(19) United States
(12) Patent Application Publication
(10) Pub. No.: US 2026/0284686 A1
(43) Pub. Date: Sep. 24, 2026

(54) MOBILE SPRAYER

(71) Applicant: Graco Minnesota Inc., Minneapolis, MN (US)

(72) Inventors: Dale D. Johnson, Shoreview, MN (US); Charles W. Dawson, Otsego, MN (US); Cody B. Bergeron, Columbus, MN (US); Brian M. Mulgrew, St. Francis, MN (US); Mark J. Brudevold, Fridley, MN (US); Tyler J. Kruzel, Otsego, MN (US); John P. Saunders, Brooklyn Park, MN (US); Daniel D. Rohling, Corcoran, MN (US); Roland M. Bedard, Lindstrom, MN (US)

(21) Appl. No.: 19/475,333

(22) PCT Filed: Apr. 16, 2024
(86) PCT No.: PCT/US2024/024768

§ 371 Date: Oct. 14, 2025

Related U.S. Application Data
(60) Provisional application No. 63/459,964, filed on Apr. 17, 2023.

(51) Int. Cl. B05B 13/00

(52) U.S. Cl. CPC B05B 13/005

(57) ABSTRACT

A mobile sprayer is configured to apply swaths of fluid to target surfaces to coat the target surfaces with the fluid. A controller of the mobile sprayer controls movement of the mobile sprayer and spraying from a spray module of the mobile sprayer. A frame of the mobile sprayer is movably supported on a ground surface by one or more displacers. The spray module is configured to displace vertically relative to a base of the frame to apply vertical swaths of the fluid on the target surface.

### CROSS-REFERENCE TO RELATED APPLICATION(S)

This application claims the benefit of U.S. Provisional Application No. 63/459,964 filed Apr. 17, 2023 and entitled “MOBILE SPRAYER,” the disclosure of which is hereby incorporated by reference in its entirety.

### BACKGROUND

This disclosure relates generally to mobile fluid spraying systems. More specifically, this disclosure relates to automated mobile painting systems.

Fluid spray systems produce an atomized fluid spray fan and apply the spray fan to a surface. The spray fan is typically in a horizontal orientation or a vertical orientation. In the horizontal orientation the fan is swept across the surface in vertical passes. In the vertical orientation the fan is swept across the surface in horizontal passes. As such, the spray fan is oriented orthogonal to the sweep direction. Typically, a user operates a spray gun to apply the fluid to the surface.

Automated painting systems are typically used to paint components, such as doors and panels. The autonomous painting systems utilize a robotic arm that moves through three-dimensional space to apply paint to the component. The robotic arms are complex and require multiple joints to provide the degree of freedom necessary to coat the components. Moreover, the robotic arm requires the component to move to a position where the arm can reach the component, as a base of the robotic arm is fixed on a factory floor.

### SUMMARY

According to an aspect of the disclosure, a mobile sprayer for spraying a plurality of vertical swaths of a fluid on a wall includes a wall-facing side configured to be oriented towards the wall, an outer side configured to be oriented away from the wall, a leading side, and a trailing side; a frame including a base having a longitudinal axis and a lateral axis; a plurality of base displacers configured to move the base along a ground surface; one or more driving motors that drive the plurality of base displacers; a spray module configured to spray the fluid onto the wall, the spray module mounted to spray out from the wall facing side; one or more movement motors configured to move the spray module relative to the base; one or more sensors that generate data regarding one or more parameters relating to the wall; a reservoir support configured to support a reservoir on the base, the reservoir configured to store a supply of the fluid on the base, the reservoir support disposed laterally between the spray module and the trailing side; and an sprayer controller configured to receive the data generated by the one or more sensors and control the one or more driving motors, the one or more movement motors, and the spray module.

According to an additional or alternative aspect of the disclosure, a mobile sprayer for spraying a plurality of vertical swaths of a fluid on a wall includes a wall facing side configured to be oriented towards the wall, an outer side configured to be oriented away from the wall, a leading side, and a trailing side; a frame including a base having a longitudinal axis and a lateral axis; a plurality of base displacers configured to move the base along a ground surface; one or more driving motors that drive the plurality of base displacers; a spray module configured to spray the fluid onto the wall, the spray module mounted to spray out from the wall facing side; one or more movement motors that are configured to move the spray module relative to the base; one or more sensors that generate data regarding one or more parameters relating to the wall; a reservoir supported on the base, the reservoir configured to store a supply of the spray fluid, the reservoir disposed laterally rearward relative to the spray module; and an sprayer controller configured to receive the data generated by the one or more sensors and control the one or more driving motors, the one or more movement motors, and the spray module.

According to another additional or alternative aspect of the disclosure, a mobile sprayer for spraying a plurality of vertical swaths of a fluid on a wall includes a wall facing side configured to be oriented towards the wall, an outer side configured to be oriented away from the wall, a leading side, and a trailing side; a frame having a base having a longitudinal axis and a lateral axis; a plurality of base displacers configured to move the base along a ground surface; one or more driving motors that drive the plurality of base displacers; a spray module configured to spray a fluid onto the wall, the spray module mounted to spray out from the wall facing side; one or more movement motors that are configured to move the spray module relative to the base; one or more sensors that generate data regarding one or more parameters relating to the wall; a reservoir supports configured to support a reservoir on the base, the reservoir configured to store a supply of the spray fluid, the reservoir support disposed laterally rearward relative to the spray module; a pump supported on the base, the pump configured to drive the spray fluid from the reservoir to the spray module, the pump disposed laterally rearward of the one or more spray modules; and an sprayer controller configured to receive the data generated by the one or more sensors and control the one or more driving motors, the one or more movement motors, and the spray module.

According to yet another additional or alternative aspect of the disclosure, a mobile sprayer for spraying a plurality of vertical swaths of a fluid on a wall includes a wall facing side configured to be oriented towards the wall, an outer side configured to be oriented away from the wall, a leading side, and a trailing side; a base having a longitudinal axis and a lateral axis; a plurality of base displacers configured to move the base along a ground surface; one or more driving motors that drive the plurality of base displacers; a spray module configured to spray the fluid onto the wall, the spray module mounted to spray out from the wall-facing side; one or more movement motors that are configured to move the spray module relative to the base; one or more sensors that generate data regarding one or more parameters relating to the wall; an interface configured to receive an input from the user; and an sprayer controller. The sprayer controller configured to receive the data generated by the one or more sensors and control the one or more driving motors, the one or more movement motors, and the one or more spray modules; receive a thickness command from the interface, the thickness command generated based on the input from the user; determine a nozzle displacement speed for a nozzle of the spray module based on the thickness command; and cause the nozzle to displace vertically based on the nozzle displacement speed.

According to yet another additional or alternative aspect of the disclosure, a mobile sprayer for spraying a plurality of vertical swaths of a fluid on a wall includes a wall facing side configured to be oriented towards the wall, an outer side configured to be oriented away from the wall, a leading side, and a trailing side; a frame including a base having a longitudinal axis and a lateral axis; a plurality of base displacers configured to move the base along a ground surface; one or more driving motors that drive the plurality of base displacers; a spray module configured to spray the fluid onto the wall, the spray module mounted to spray out from the wall-facing side; one or more movement motors that are configured to move the spray module relative to the base; one or more sensors that generate data regarding one or more parameters relating to the wall; an interface configured to receive an input from the user; and a sprayer controller. The sprayer controller configured to receive the data generated by the one or more sensors and control the one or more driving motors, the one or more movement motors, and the spray module; receive a thickness command from the interface, the thickness command generated based on the input from the user; determine a speed for the spray module to travel to apply the fluid at a coating thickness provided by the thickness command; and control the one or more movement motors to move the spray module based on the determined speed.

According to yet another additional or alternative aspect of the disclosure, a mobile sprayer for spraying a plurality of vertical swaths of a fluid on a wall includes a wall facing side configured to be oriented towards the wall, an outer side configured to be oriented away from the wall, a leading side, and a trailing side; a frame including a base having a longitudinal axis and a lateral axis; a plurality of base displacers configured to move the base along a ground surface; one or more driving motors that drive the plurality of base displacers; a spray module configured to spray a fluid onto the wall, the spray module mounted to spray out from the wall-facing side; one or more movement motors that are configured to move the spray module relative to the base; one or more sensors that generate data regarding one or more parameters relating to the wall; an interface configured to receive an input from the user; and a sprayer controller. The sprayer controller configured to receive the data generated by the one or more sensors and control the one or more driving motors, the one or more movement motors, and the spray module; receive fan width information providing a width of a spray pattern emitted from the spray module onto the wall; determine a travel distance for the mobile sprayer based on the fan width information; and control the one or more driving motors to move the spray module between adjacent vertical swaths of the plurality of vertical swaths based on the determined travel distance.

According to yet another additional or alternative aspect of the disclosure, a mobile sprayer for spraying a plurality of vertical swaths of a fluid on a wall includes a wall facing side configured to be oriented towards the wall, an outer side configured to be oriented away from the wall, a leading side, and a trailing side; a frame including a base having a longitudinal axis and a lateral axis; a plurality of base displacers configured to move the base along a ground surface; one or more driving motors that drive the plurality of base displacers; a lower spray module configured to spray the fluid onto the wall, the lower spray module mounted to spray out from the wall-facing side; an upper spray module configured to spray the fluid onto the wall, the upper spray module mounted to spray out from the wall-facing side, and the upper spray module spaced vertically from the lower spray module; one or more movement motors that are configured to move the lower spray module relative to the base; one or more sensors that generate data regarding one or more parameters relating to the wall; and an sprayer controller configured to receive the data generated by the one or more sensors and control the one or more driving motors, the one or more movement motors, and the lower spray module.

According to yet another additional or alternative aspect of the disclosure, a mobile sprayer for spraying a plurality of vertical swaths of a fluid on a wall includes a wall facing side configured to be oriented towards the wall, an outer side configured to be oriented away from the wall, a leading side, and a trailing side; a frame including a base having a longitudinal axis and a lateral axis; a plurality of base displacers configured to move the base along a ground surface; one or more driving motors that drive the plurality of base displacers; a lower spray module configured to spray the fluid onto the wall, the lower spray module mounted to spray out from the wall-facing side; an upper spray module configured to spray the fluid onto the wall, the upper spray module mounted to spray out from the wall-facing side, and the upper spray module spaced vertically from the lower spray module; one or more movement motors that are configured to move the spray module relative to the base; one or more sensors that generate data regarding one or more parameters relating to the wall; and a sprayer controller. The sprayer controller configured to receive the data generated by the one or more sensors and control the one or more driving motors, the one or more movement motors, the upper spray module, and lower spray module; and control spraying by the lower spray module and the upper spray module such that a lower vertical stripe applied by the lower spray module and an upper vertical stripe applied by the upper spray module are simultaneously applied, and such that the upper vertical stripe meets the lower vertical stripe to form a single vertical swath of the plurality of vertical swaths.

According to yet another additional or alternative aspect of the disclosure, a mobile sprayer for spraying a plurality of vertical swaths of a fluid on a wall includes a wall facing side configured to be oriented towards the wall, an outer side configured to be oriented away from the wall, a leading side, and a trailing side; a frame, the frame including a base having a longitudinal axis and a lateral axis and a mast extending vertically from the base; a plurality of base displacers configured to move the base along a ground surface; one or more driving motors that drive the plurality of base displacers; a lower spray module configured to spray the fluid onto the wall, the lower spray module mounted to spray out from the wall-facing side; an upper spray module configured to spray the fluid onto the wall, the upper spray module mounted to spray out from the wall-facing side, the upper spray module spaced vertically from the lower spray module, and the upper spray module is disposed vertically above the frame; one or more movement motors that are configured to move the lower spray module relative to the base; one or more sensors that generate data regarding one or more parameters relating to the wall; and a sprayer controller configured to receive the data generated by the one or more sensors and control the one or more driving motors, the one or more movement motors, and the lower spray module.

According to yet another additional or alternative aspect of the disclosure, a mobile sprayer for spraying a plurality of vertical swaths of a fluid on a wall includes a wall facing side configured to be oriented towards the wall, an outer side configured to be oriented away from the wall, a leading side, and a trailing side; a frame including a base having a longitudinal axis and a lateral axis; a plurality of base displacers configured to move the base along a ground surface; one or more driving motors that drive the plurality of base displacers; a lower spray module configured to spray the fluid onto the wall, the lower spray module mounted to spray out from the wall-facing side; a trunk extending from the lower spray module; an upper spray module configured to spray the fluid onto the wall, the upper spray module mounted on the trunk and oriented to spray out from the wall-facing side, and the upper spray module spaced vertically from the lower spray module by the trunk; one or more movement motors that are configured to move the lower spray module relative to the base; one or more sensors that generate data regarding one or more parameters relating to the wall; and an sprayer controller configured to receive the data generated by the one or more sensors and control the one or more driving motors, the one or more movement motors, and the lower spray module.

According to yet another additional or alternative aspect of the disclosure, a mobile sprayer for spraying a plurality of vertical swaths of a fluid on a wall includes a wall facing side configured to be oriented towards the wall, an outer side configured to be oriented away from the wall, a leading side, and a trailing side; a frame including a base having a longitudinal axis and a lateral axis; a plurality of base displacers configured to move the base along a ground surface; one or more driving motors that drive the plurality of base displacers; a plurality of spray modules configured to spray the fluid onto the wall, the plurality of spray modules mounted to spray out from the wall-facing side; one or more movement motors that are configured to move the plurality of spray modules relative to the base; one or more sensors that generate data regarding one or more parameters relating to the wall; and a sprayer controller configured to receive the data generated by the one or more sensors and control the one or more driving motors, the one or more movement motors, and the plurality of spray modules. The plurality of spray modules includes a first module group including a first spray module; and a second module group including a second spray module and a third spray module.

According to yet another additional or alternative aspect of the disclosure, a mobile sprayer for spraying a plurality of vertical swaths of a fluid on a wall includes a wall facing side configured to be oriented towards the wall, an outer side configured to be oriented away from the wall, a leading side, and a trailing side; a frame including a base having a longitudinal axis and a lateral axis; a plurality of base displacers configured to move the base along a ground surface; one or more driving motors that drive the plurality of base displacers; one or more spray modules configured to spray a fluid onto the wall, the one or more spray modules mounted to spray out from the wall facing side; one or more movement motors that are configured to move the one or more spray modules relative to the base; one or more sensors that generate data regarding one or more parameters relating to the wall; and a sprayer controller configured to receive the data generated by the one or more sensors and control the one or more driving motors, the one or more movement motors, and the one or more spray modules.

### BRIEF DESCRIPTION OF THE DRAWINGS

FIG. 1A is a first isometric view of a mobile sprayer.

FIG. 1B is a second isometric view of the mobile sprayer.

FIG. 2 is an isometric view of the mobile sprayer with a reservoir and pumping assembly removed for clarity.

FIG. 3A is a side elevational view of the mobile sprayer with the spray module in a lower spray position.

FIG. 3B is a side elevational view of the mobile sprayer with the spray module in an upper spray position.

FIG. 4 is a block diagram of a mobile sprayer.

FIG. 5 is a block diagram of a top view of a mobile sprayer.

FIG. 6 is an isometric view of a mobile sprayer.

FIG. 7A is an enlarged elevational view showing spray modules of a mobile sprayer.

FIG. 7B is an enlarged top view showing spray modules of a mobile sprayer.

FIG. 8 is a block diagram top view of a mobile sprayer.

FIG. 9 is a side block diagram of a mobile sprayer.

FIG. 10A is a side elevational view showing a mobile sprayer in a first state.

FIG. 10B is a side elevational view showing a mobile sprayer in a second state.

FIG. 10C is a side elevational view showing a mobile sprayer in a third state.

### DETAILED DESCRIPTION

The present disclosure concerns mobile sprayers. The mobile sprayers of the present disclosure operate either partially or fully autonomously in spraying structures. A wall will be used as an example of a structure that is sprayed, however other structures can be sprayed instead. Such a wall can be the wall of the building, such as an interior or exterior wall, amongst other options. Typically paint will be sprayed on the wall by the mobile sprayer, and paint will be used herein as an example of the spray fluid herein, however it will be understood that other types of coatings can be sprayed, such as lacquers, texture, putty, filling compound, finishes, and other coatings.

The mobile sprayers of the present disclosure can be configured to operate autonomously. The mobile sprayers can be configured to apply a plurality of swaths of fluid to the wall. The mobile sprayers can be configured to apply a plurality of vertical or horizontal swaths of the fluid on the wall. The mobile sprayer can be configured to autonomously move between and spray adjacent fluid swaths of the plurality of fluid swaths. The mobile sprayer can, in some examples, be referred to as an “autonomous mobile sprayer” and/or as an “AMS”.

The mobile sprayer can include a spray module configured to output a spray of the fluid onto the wall. A reservoir can be supported by a frame of the mobile sprayer. The reservoir stores a supply of the fluid for spraying onto the wall by the spray module. The reservoir can be disposed rearward of the spray module relative to a travel direction of the mobile sprayer along a travel path of the mobile sprayer.

A pump assembly can be supported by a frame of the mobile sprayer. The pump assembly includes a pump that drives the fluid from the reservoir to the spray module under pressure for generating the atomized fluid spray. The pump assembly can be disposed rearward of the spray module.

The mobile sprayer can include a reservoir support that is configured to support the reservoir on a base of the frame of the mobile sprayer. The reservoir support can define a reservoir receiving area in which one or more portions of the reservoir support extend vertically to radially define the reservoir receiving area relative to a vertical axis through the reservoir support. The vertically extending portions of the reservoir support can radially overlap with the reservoir with the reservoir mounted to the reservoir support.

In some examples, the reservoir support is configured to adjustably position the reservoir relative to the base of the frame of the mobile sprayer. The reservoir support can be configured to shift vertically relative to the base such that the reservoir can be supported at different vertical heights relative to the base.

Mobile sprayers according to the disclosure can include a plurality of spray nozzles configured to emit the fluid. The mobile sprayer can include an upper nozzle and a lower nozzle that are spaced vertically from each other. The upper nozzle and the lower nozzle can be vertically aligned. A sprayer controller of the mobile sprayer can be configured to control spraying from one or both of the upper and lower nozzles. The upper nozzle can be disposed vertically above the frame of the mobile sprayer.

The plurality of spray nozzles can be spaced laterally relative to each other. The sprayer controller can be configured to control spraying by each of the laterally spaced spray nozzles. The sprayer controller can be configured to control spraying based on module groups of the laterally spaced spray modules. In some examples, the module groups include a first module group having a first spray module and a second module group having multiple spray modules, such as a pair of spray modules. The first module group can be disposed within a spray envelope of the second module group. The first module group can be disposed laterally between spray modules of the second module group.

A sprayer controller can control operation of the mobile sprayer. The sprayer controller can be configured to control one or more drive motors that drive displacement of a base of the mobile sprayer relative to the wall. The sprayer controller can be configured to control one or more movement motors that drive displacement of the spray module relative to the base. The sprayer controller can be configured to control the spray module.

The sprayer controller can be configured to control a speed of one or more spray modules of the mobile sprayer relative to the wall during fluid spray emission to control a thickness of the coating applied to the wall. The sprayer controller can determine the speed of the one or more spray modules based on an input to an interface. The input indicates a coating thickness. The input can be provided to the interface by the user. The sprayer controller can be configured to control operation of the one or more movement motors to move the one or more spray modules based on the determined speed.

The sprayer controller can be configured to determine a travel distance for the mobile sprayer between adjacent vertical swaths of the plurality of vertical swaths. The sprayer controller can determine the travel distanced based on an input to an interface. The input indicates a fan width. The input can be provided to the interface by the user. The sprayer controller can be configured to control operation of the one or more drive motors to move the assembly controller between the adjacent vertical swaths based on the determined travel distance.

Components can be considered to radially overlap when those components are disposed at common axial locations along an axis. A radial line extending orthogonally from axis will extend through each of the radially overlapping components. Components can be considered to axially overlap when those components are disposed at common radial and circumferential locations relative to the axis. An axial line parallel to the axis will extend through the axially overlapping components. Components can be considered to circumferentially overlap when those components are disposed at common radial distance and axial locations along the axis, such that a circle centered on the axis passes through each of the circumferentially overlapping components.

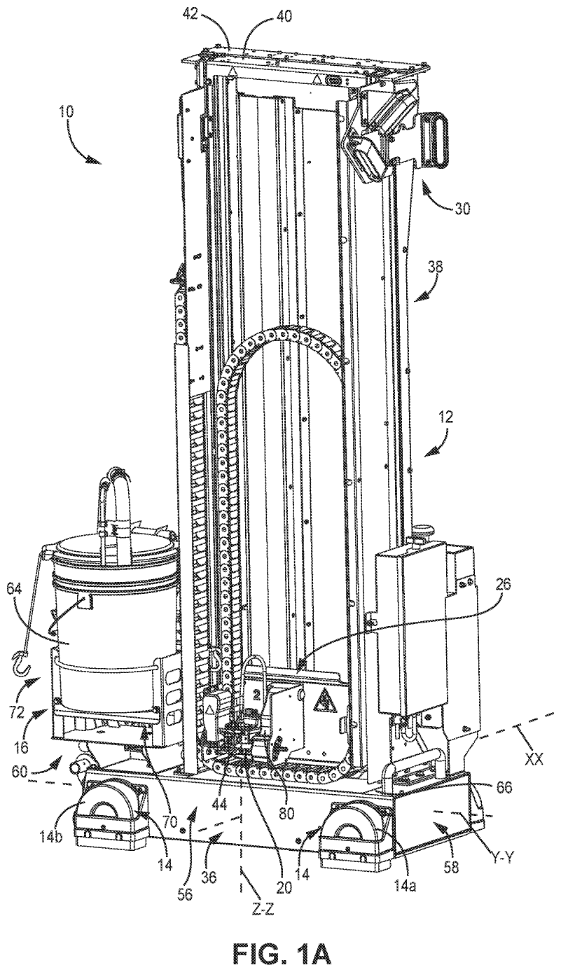

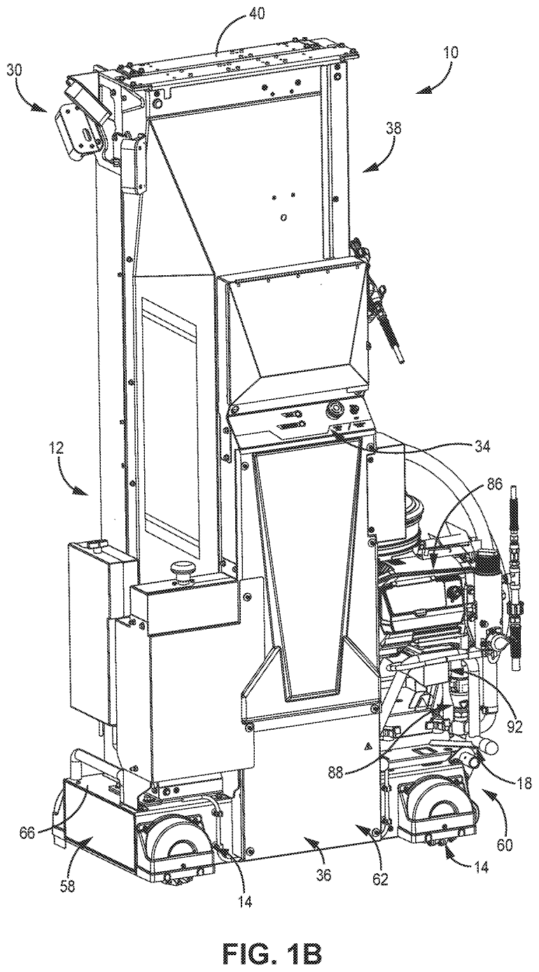

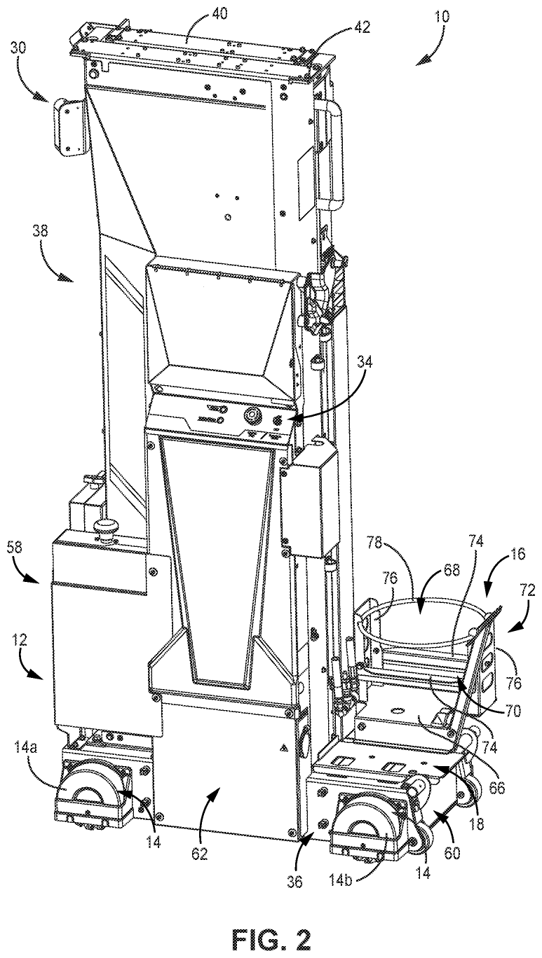

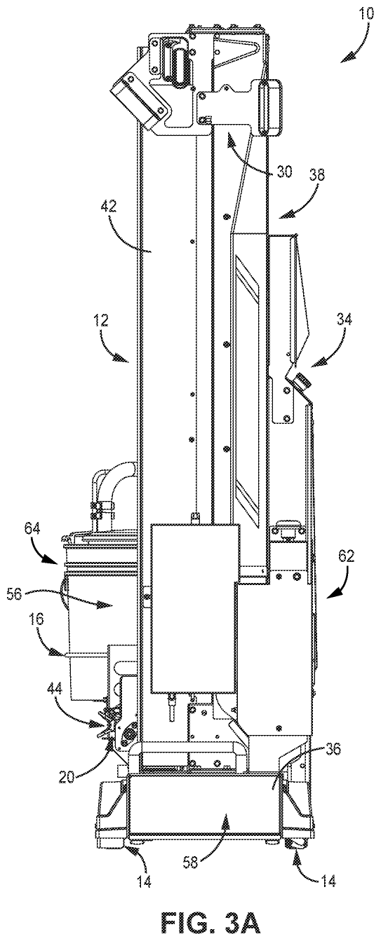

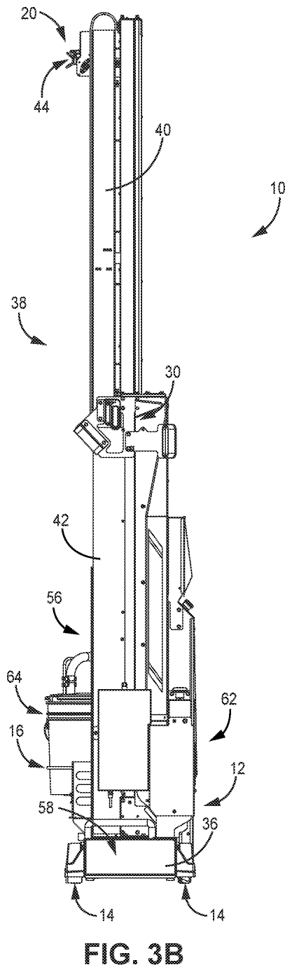

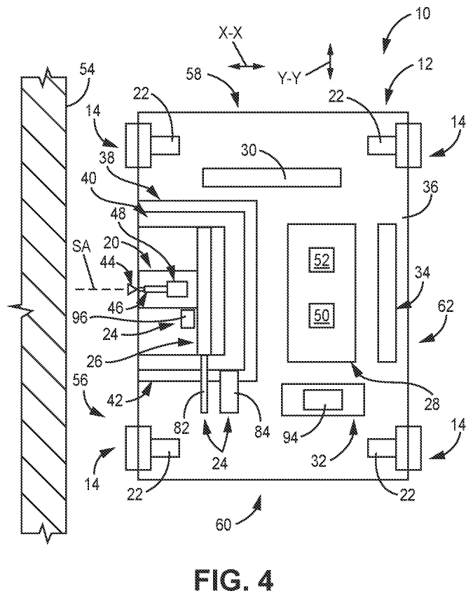

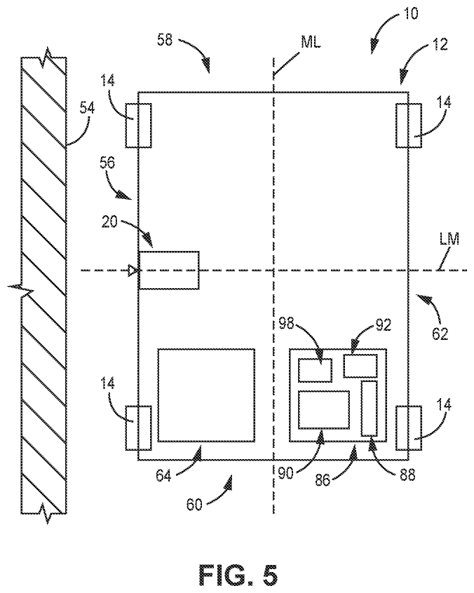

FIG. 1A is a first isometric view of mobile sprayer 10. FIG. 1B is a second isometric view of mobile sprayer 10. FIG. 2 is a third isometric view of mobile sprayer 10 with pump module 86 and reservoir 64 removed for clarity. FIG. 3A is a side elevational view of mobile sprayer 10 with spray module 20 in a lower spray position. FIG. 3B is a side elevational view of mobile sprayer 10 with spray module 20 in an upper spray position. FIG. 4 is a block diagram of mobile sprayer 10. FIG. 5 is a block diagram of a top view of mobile sprayer 10. FIGS. 1A-5 are discussed together. Frame 12, displacers 14, reservoir support 16, pump support 18, spray module 20, drive motors 22, movement motors 24, elevator 26, sprayer controller 28, sensors 30, power module 32, and interface 34 of mobile sprayer 10 are shown. Base 36 and mast 38 of frame 12 are shown. Upper mast 40 and lower mast 42 of mast 38 are shown. Nozzle 44, spray valve 46, and valve actuator 48 of spray module 20 are shown. Control circuitry 50 and memory 52 of sprayer controller 28 are shown. Mobile sprayer 10 includes longitudinal axis X-X, lateral axis Y-Y, and vertical axis Z-Z that are defined relative to the mobile sprayer 10.

In the example shown, the mobile sprayer 10 is configured to shift laterally relative to the target surface 54 during spray operations. The mobile sprayer 10 can be configured to shift laterally along lateral axis Y-Y between adjacent vertical fluid swaths of a plurality of vertical fluid swaths applied by the mobile sprayer 10. The mobile sprayer 10 can be configured such that the base 36 is caused to pivot during maneuvering of mobile sprayer 10 between applying vertical swaths. The mobile sprayer 10 can be configured to cause the spray module 20 to displace vertically, such as along or parallel to the vertical axis Z-Z, during spraying of the vertical swath. In some examples, the base 36 can remain laterally and longitudinally stationary during emission of the spray fluid from the spray module 20.

Frame 12 supports various other components of mobile sprayer 10. In the example shown, frame 12 includes base 36 and mast 38 that extends from base 36. Mast 38 extends vertically from base 36 in the example shown. The base 36 supports the mast 38 while the mast 38 extends vertically from the base 36. The mast 38 extends along the vertical axis Z-Z. The base 36 can extend laterally and longitudinally relative to the mast 38. It is understood that the frame 12 may be composed of different components in various other examples. The base 36 is supported on the ground surface by a plurality of displacers 14. Displacers 14 are configured to move to cause base 36, and thus mobile sprayer 10, to displace along the ground surface. In the example shown, displacers 14 are formed as wheels. While wheels are used herein, it is understood that other structures that facilitate movement of the base 36 may additionally or alternatively be used, such as tracks. The displacers 14 can take various forms of rolling structures, including but not limited to omni-directional or mecanum wheels.

Displacers 14 are driven by respective drive motors 22 in the example shown. The drive motors 22 can be electric brushed or brushless motors, among other options. In this example, a separate drive motor 22 is provided for each displacer 14 for individual driving that displacer 14. It is understood, however, that different configurations are possible. For example, mobile sprayer 10 can include a single drive motor 22 for driving displacement of multiple of displacers 14, can include multiple drive motors 22 that each drive displacement of one or more displacers 14, etc. As such, mobile sprayer 10 can include one or more drive motors 22 for causing displacement of base 36 relative to the target surface 54.

The shape of the footprint of the mobile sprayer 10 is generally rectangular. The mobile sprayer 10 includes a wall-facing side 56, a leading side 58, a trailing side 60, and an outward side 62. The mobile sprayer 10 orientates the wall-facing side 56 during spraying to face the wall being sprayed. The wall-facing side 56 is oriented longitudinally towards the wall in the example shown. The mobile sprayer 10 moves along the wall being targeted for spraying, with a leading side 58 of the mobile sprayer 10 leading such movement while a trailing side 60 of the mobile sprayer 10 trails such movement. The leading side 58 and the trailing side 60 are on opposite sides of the mobile sprayer 10. The mobile sprayer 10 is configured to move laterally towards the leading side 58 in the example shown. The outward side 62 is opposite the wall-facing side 56. The outward side 62 can face out into the center or main area of the room or other area being sprayed, or away from the building of which the exterior is being sprayed. Generally, the outward side 62 faces away from the wall being targeted for spraying.

The mobile sprayer 10 supports a reservoir 64. In this embodiment, the reservoir 64 is a bucket, more specifically in this example a five gallon bucket. In this example, the reservoir 64 is supported by reservoir support 16. The reservoir support 16 can be disposed on base 36 to support the reservoir 64 on the base 36. Reservoir support 16 supports the reservoir 64 such that the reservoir 64 moves with mobile sprayer 10 during spray operations. The reservoir support 16 can support the reservoir 64 such that a bottom end of the reservoir 64 is elevated above a top side 66 of the base 36. The bottom end of the reservoir 64 can be maintained out of contact and spaced from the top side 66 of the base 36.

The reservoir support 16 can elevate the reservoir 64 such that the reservoir 64 is easily accessible during operation of mobile sprayer 10. For example, the elevated reservoir 64 can be easier for a user to access during spray operations to refill reservoir 64 without interrupting spray operations of mobile sprayer 10. In some examples, reservoir support 16 is adjustable. For example, reservoir support 16 can be vertically adjustable to elevate reservoir 64 between different heights. In some examples, reservoir support 16 can be adjustable between different heights with reservoir 64 mounted on and supported by reservoir support 16. In some examples, reservoir support 16 can be secured in various different vertical positions to dispose reservoir 64 at the various different vertical positions. The reservoir support 16 is configured to displace vertically relative to the base 36 such that the reservoir support 16 is positionable at a plurality of different heights away from the base 36.

Reservoir support 16 includes base support 70 and side retainer 72. The reservoir support 16 defines a reservoir receiving area 68. The reservoir receiving area 68 is configured to receive a portion of the reservoir 64 with the reservoir 64 mounted on the mobile sprayer 10. The reservoir receiving area 68 is open vertically upward such that a reservoir 64 can enter into and exit from the reservoir receiving area 68 by vertical displacement relative to the base 36 and reservoir support 16. The reservoir receiving area 68 is blocked vertically downward to support the reservoir 64 vertically above the base 36. The reservoir receiving area 68 is defined radially outward from a vertical axis through the reservoir support 16. The reservoir receiving area 68 being outwardly defined by structure of the reservoir support 16 prevents the reservoir 64 from shifting off of the reservoir support 16 (e.g., laterally and/or longitudinally) during operation of mobile sprayer 10.

In the example shown, the base support 70 is configured to interface with the lower end of a reservoir 64 to support the reservoir 64 on the base 36. The base support 70 can be considered to axially overlap with the reservoir 64 relative to a vertical axis through the reservoir support 16. Base support 70 includes base plates 74 that are configured to overlap with reservoir 64 to prevent reservoir 64 from shifting vertically downward towards base 36. In the example shown, a gap is formed between base plates 74, though it is understood that not all examples are so limited. In some examples, base support 70 can be configured as a single plate or as other structure that can limit vertical displacement of reservoir 64 towards base 36.

Side retainer 72 extends from base support 70. The side retainer 72 extends vertically from the base support 70 in the example shown. The side retainer 72 can include one or more portions that are spaced from and not directly connected to the base support 70. In the example shown, the side retainer 72 is formed by multiple components connected together, though it is understood that not all examples are so limited. Side retainer 72 are configured to overlap with reservoir 64 to maintain reservoir 64 on base support 70. Side retainer 72 can be considered to radially overlap with reservoir 64 relative to a vertical axis through reservoir support 16.

Side retainer 72 are configured to prevent the reservoir 64 from displacing laterally and/or longitudinally off of base support 70. Side retainer 72 can extend fully or partially about reservoir 64 to maintain reservoir 64 on base support 70. In some examples, side retainer 72 can include a plurality of side portions that each overlap with the reservoir 64 and partially extend about the reservoir 64. In some examples, the side retainer 72 can include one or more portions that extend fully annularly about the reservoir 64.

Side retainer 72 include side plates 76 and ring 78 in the example shown. Side plates 76 extend vertically from base support 70. Ring 78 is supported by side plates 76. In the example shown, ring 78 is an annular ring that is configured to extend fully about the reservoir 64. The ring 78 can be considered to extend fully annularly about the reservoir receiving area 68. Ring 78 is spaced vertically from base support 70.

In the example shown, the displacers 14 include at least one forward displacer 14a and at least one rearward displacer 14b. The reservoir support 16 is aligned with the at least one rear displacer 14b laterally along the base 36. The reservoir support 16 is disposed directly vertically above a rotational axis of the at least one rear displacer 14b in the example shown. The reservoir support 16 can be disposed directly vertically above the at least one rear displacer 14b. The reservoir support 16 being disposed over the rear displacers 14b positions the heavy reservoir 64 directly vertically above the rear wheels, providing better balance to mobile sprayer 10.

Frame 12 supports spray module 20. In the example shown, base 36 supports spray module 20 relative to the ground surface. In the example shown, the mobile sprayer 10 is configured such that base 36 displaces relative to the target surface 54 to shift the spray module 20 laterally relative to the target surface 54, though it is understood that not all examples are so limited. It is understood that mobile sprayer 10 can include one or more spray modules 20, as discussed in more detail below. In the example shown, the mast 38 is supported on the base 36, and the spray module 20 is supported by the mast 38. The spray module 20 includes a spray nozzle 44. Spray nozzle 44 can include an outlet for atomizing paint or other spray fluid that is sprayed onto the wall. The spray module 20 can also include a spray valve 46 which controls the release of paint from the spray nozzle 44. The spray valve 46 can be needle valve actuated by a solenoid, amongst other options, such that the spray valve 46 is electronically controlled. It is understood that, in various other examples, the spray valve 46 can be configured such that the spray valve 46 opens in response to fluid pressure exceeding a threshold pressure. The spray module 20 is located on the wall-facing side 56 of the mobile sprayer 10, such that the spray module 20 is positioned spray fluid onto the wall.

Spray module 20 is configured to shift vertically to apply vertical swaths of the fluid onto the target surface 54. The spray module 20 can be moved up and down by elevator 26. Elevator 26 may include one or more rails along which the support carriage 80 for the spray module 20 can move. One or more electric movement motors 24 may move the spray module 20 up-and-down the mast 38 via the elevator 26. In the example shown, the elevator 26 is configured to be displaced vertically by elevator motor 82, which can be an electric motor. Elevator motor 82 can be considered to form a movement motor 24 of the mobile sprayer 10 that causes displacement of nozzle 44 of spray module 20 relative to target surface 54. Elevator motor 82 can stay stationary, such as on or near the base 36 of the mobile sprayer 10. The elevator motor 82 can output rotational motion which moves a pulley which raises and lowers the spray module 20 along the mast 38, which pulley can be or form part of the elevator 26 in such an example.

In the example shown, mast 38 includes lower mast 42 and upper mast 40. Lower mast 42 is connected to base 36. Upper mast 40 can move vertically relative to lower mast 42, such as along displacement axis DA of spray module 20. Upper mast 40 can be configured to move telescopically relative to lower mast 42. In some examples, upper mast 40 can be received at least partially within lower mast 42. Upper mast 40 being movable relative to lower mast 42 can extend the vertical reach of mobile sprayer 10 relative to a fixed height mast. Elevator 26 can be configured to displace along the full vertical extent of mast 38 with upper mast 40 fully extended relative to lower mast 42. Mobile sprayer 10 can include mast motor 84 for actuating displacement of upper mast 40 relative to lower mast 42. Mast motor 84 can be an electric motor. Mast motor 84 can be considered to form one of movement motors 24 that causes displacement of nozzle 44 of spray module 20 relative to target surface 54.

In some examples, spray module 20 is configured such that spray nozzle 44 can pivot during spray operations. Nozzle 44 can be aligned to spray along spray axis SA. In some examples, the spray axis SA can be disposed at an orientation orthogonal to the target surface 54, though it is understood that spray axis SA can, in some examples, be disposed at or reorientable to orientations other than orthogonal. Nozzle 44 is oriented to spray longitudinally outward from mobile sprayer 10 and towards the wall target surface 54. In some examples, nozzle 44 can be disposed at or reorientable to one or more orientations that are disposed vertically upward or downward in addition to longitudinally outward.

Nozzle 44 is configured at atomize the spray fluid and generate the desired spray pattern. The nozzle 44 can be configured to tilt upwards and/or downwards during spray operations, allowing the spray to reach above and below the vertical limits of travel for the spray module 20. In some examples, the nozzle 44 can be configured to pivot continuously during vertical displacement. For example, nozzle 44 can be oriented in a downward tilt orientation, indicated by dashed line DO, at a lower end of travel for a vertical swath, the nozzle 44 can pivot continuously such that nozzle 44 is oriented orthogonal at the midpoint of the vertical swath and nozzle 44 is oriented in an upward tilt orientation, indicated by dashed line UO, at an upper end of travel for the vertical swath. In some examples, the nozzle 44 can be configured to pivot at or near an end of travel of the spray module 20. For example, the nozzle 44 can be in the downward tilt orientation at a downward end of travel for a vertical swath, the nozzle 44 can tilt to orthogonal prior to the midpoint, such as within a threshold distance of the downward end of travel, and the nozzle 44 can be oriented orthogonal until tilting upward to the upward tilt orientation as the nozzle 44 approaches the upward end of travel for the vertical swath.

Nozzle actuator 96, which can be electrically powered, is operatively connected to spray nozzle 44 to cause tilting of spray nozzle 44. The nozzle actuator 96 can be connected to spray module 20 to cause tilting of spray nozzle 44. The nozzle actuator 96 can be a rotary or linear actuator, among other options. It is understood that the nozzle actuator can be powered in any desired manner, such as electrically, pneumatically, or hydraulically, among other options. In some examples, sprayer controller 28 can control pivoting of nozzle 44, such as based on any desired variable. The mobile sprayer 10 can be configured such that nozzle 44 can pivot in any desired manner, such as disclosed in International Application No. PCT/US2020/0663262, assigned to Graco Minnesota, Inc., the disclosure of which is hereby incorporated by reference in its entirety. The nozzle actuator 96 can be considered to form a movement motor 24 that causes displacement of nozzle 44 relative to the target surface 54.

The spray module 20 is supported on mobile sprayer 10 such that spray module 20 can move vertically relative to base 36. In some examples, the spray module 20 is supported on mobile sprayer 10 such that the spray module 20 is restricted from and cannot move horizontally relative to base 36. In some examples, the spray module 20 is supported on mobile sprayer 10 such that the spray module 20 is restricted from and cannot move laterally or longitudinally relative to base 36. It is understood, however, that not all examples are so limited. For example, spray module 20 can be supported on an articulating arm that can displace spray module 20 laterally and/or longitudinally in addition to vertically.

In the example shown, each spray module 20 includes spray valve 46 and spray nozzle 44. The spray valve 46 is actuatable between an open state, in which spray fluid can flow to the spray nozzle 44 to be atomized by the spray nozzle 44, and a closed state, in which the spray valve 46 prevents the spray fluid from flowing to and through the spray nozzle 44. The spray modules 20 further include a valve actuator 48. The valve actuator 48 is operatively connected to the spray valve 46 to control actuation of the spray valve 46. The valve actuator 48 can be configured to mechanically displace the spray valve 46. The valve actuator 48 can be formed by one or more components. For example, the valve actuator 48 can includes a first component configured to displace the spray valve 46 to the open state and a second component configured to displace the spray valve 46 to the closed state.

In some examples, the valve actuator 48 can include a solenoid. The sprayer controller 28 can control actuation of the solenoid, such as by controlling provision of electrical energy to the solenoid, to control actuation of the spray valve 46. In some examples, the solenoid can be a single acting solenoid configured to displace the spray valve 46 from one state to the other (e.g., from closed to open). In some examples, the solenoid can be a double acting solenoid configured to displace the spray valve 46 between the states (e.g., from closed to open and from open to closed). In some examples, the valve actuator 48 can include a spring configured to actuate the spray valve 46 to the closed state. For example, valve actuator 48 can be configured such that a solenoid electromechanically pulls the spray valve 46 open and a spring mechanically returns the spray valve 46 closed.

In some examples, the spray valve 46 is configured as a pressure actuated valve that is closed by respective springs when the pressure of the spray fluid is below a threshold pressure but opened up by the pressure when the pressure of the spray is above the threshold corresponding to when the spray module 20 sprays. The opening pressure can be greater than the closing pressure in some examples.

The mobile sprayer 10 includes a plurality of sensors 30. The sensors 30 are located on the leading side 58 to identify and navigate about structures that are in the path of the mobile sprayer 10 along the wall being sprayed. In some examples, sensors 30 may also be mounted on the wall-facing side 56 in order to analyze the wall surface being sprayed. It is understood that one or more sensors 30 may be located on any other side of the mobile sprayer 10. The one or more sensors 30 can be mounted to base 36, such as on one or both of a top side 66 and one or more of lateral/forward/rearward sides of base 36. The one or more sensors 30 can additionally or alternatively be mounted to mast 38.

In the example shown, one or more of the sensors 30 are mounted on the lower mast 42 such that the sensors 30 remain at a fixed height during spray application. As shown, the mobile sprayer 10 can be configured such that nozzle 44 can be positioned vertically above the sensors 30 with the spray module 20 at an upward end of travel for the module 20. The sensors 30 have a sensing envelope which is the area within which the sensors 30 can generate data. For example, area disposed laterally rearward of sensors 30 can be outside of the sensing envelope to not be sensed by sensors 30. In some examples, the sensors 30 are not oriented rearward relative to the trailing side 60. In the example shown, the reservoir support 16 and pump module 86 are disposed outside of the sensing envelope. In some examples, the spray module 20 can be disposed vertically above the sensing envelope when at the upward limit of travel. As such, the nozzle 44 can, in some examples, be configured to apply spray fluid to surfaces outside of the sensing envelope of the sensors 30.

The mobile sprayer 10 includes a pump module 86. The pump module 86 can be a sprayer used in manual application of applying paint to a wall with a hand actuated gun instead of a spray module 20. For example, the pump module 86 can be a Graco 390PC battery powered sprayer, which includes a replaceable lithium-ion battery that powers an internal controller and electric motor which drives a piston pump. Pump module 86 includes a pump motor 90 for driving displacement of the pump 88 of pump module 86. The pump motor 90 can be an electric motor. The pump 88 can be a displacement pump, such as a double displacement pump among other options. The pump 88 can include a piston or other structure that is reciprocatingly driven to pump the spray fluid.

Power module 32 is configured to provide power to one or more electrical components of mobile sprayer 10. Power module 32 can be formed by one or more batteries. In some examples, the one or more batteries are removable and replaceable. In additional or alternative examples, the one or more batteries are rechargeable. In some examples, pump module 86 includes a pump battery 92a configured to provide power to electrical components of pump module 86, such as pump motor 90, while mobile sprayer 10 includes a sprayer battery 94b that is configured to provide power to electrical components of mobile sprayer 10, such as drive motors 22, movement motors 24, and spray module 20.

In some examples, pump module 86 can be lifted off of the mobile sprayer 10 and used to spray paint separately and remounted. The pump module 86 outputs paint to a first end of a hose. Conventionally, a manual spray gun is attached to a second end of the hose, but in the case of the mobile sprayer 10, the second end of the hose is connected to the spray module 20 to supply the spray module 20 with paint output under pressure by the pump module 86. The pump module 86 can continuously supply paint to the spray module 20 when the spray module 20 is spraying, and pump module 86 can maintain pressure within the hose and upstream of spray valve 46 when the spray module 20 is not spraying.

The mobile sprayer 10 includes interface 34. In the example shown, interface 34 is located on the outward side 62. It can be advantageous to locate the interface 34 on the outward side 62 because that may be the easiest side for an operator to approach the mobile sprayer 10 while the mobile sprayer 10 is moving and/or spraying and/or positioned for spray operations. In the example shown, the interface 34 is disposed on outward side 62. In the example shown, the interface 34 is disposed on outward side 62 of mast 38. The interface 34 can be disposed outside of the sensing envelope. Positioning the interface 34 outside of the sensing envelope can allow the user to approach the mobile sprayer 10 and provide inputs to the mobile sprayer 10 without entering the sensing envelope and potentially affecting spray operations of the mobile sprayer 10. As such, the user can easily approach mobile sprayer 10 during spray operations to provide inputs and adjust operation of mobile sprayer 10.

The interface 34 can include one or more input elements that facilitate communications between users and machines. For example, interface 34 can include one or more of a screen (e.g., touchscreen), buttons, dials, switches, and/or other input/output elements. While the interface 34 is shown as mounted to the frame 12, part or all of the interface 34 may be remote from the frame 12 and may communicate wirelessly, such as with sprayer controller 28. For example, a tablet touchscreen, smart phone, or laptop may be used communicate wirelessly with control circuitry supported by the frame 12 of the mobile sprayer 10, the tablet touchscreen, smart phone or laptop functioning for both inputting of commands and outputting of monitoring information, amongst other things.

Mobile sprayer 10 is configured to move about a job site and apply sprays of a spray fluid onto a target surface 54, such as interior and/or exterior walls. The mobile sprayer 10 can be configured such that the base 36 traverses relative to the target surface 54 while spray module 20 is maintained steady and nozzle 44 is oriented to emit a vertically oriented spray fan to apply horizontal swaths of the spray fluid. The mobile sprayer 10 can be configured such that the base 36 stays stationary relative to the surface while the spray module 20 is traversed vertically relative to the surface and the nozzle 44 is oriented to emit a horizontally oriented spray fan to apply vertical swaths of the spray fluid.

The mobile sprayer 10 includes sprayer controller 28. Sprayer controller 28 includes control circuitry 50 and memory 52. Sprayer controller 28 is operatively connected to other components of mobile sprayer 10 to control operation of the other components of mobile sprayer 10. Sprayer controller 28 is operatively connected to spray module 20, electrically and/or communicatively, to control spraying by spray module 20. Sprayer controller 28 is operatively connected to drive motors 22 to control displacement of mobile sprayer 10 along a ground surface and relative to a wall. Sprayer controller 28 is operatively connected to movement motors 24 to control vertical displacement and positioning of spray module 20 and spray nozzle 44. Sprayer controller 28 can, in some examples, be operatively connected to pump controller 98 of the pump module 86 to communicate with the pump module 86, such as to provide commands to start or stop the pump motor 90 to control pumping by pump 88.

Sprayer controller 28 is configured to store software, implement functionality, and/or process instructions. Sprayer controller 28 is configured to perform any of the functions discussed herein, including receiving an output from any sensor referenced herein, detecting any condition or event referenced herein, and controlling operation of any components referenced herein. Sprayer controller 28 can be of any suitable configuration for controlling operation of components of mobile sprayer 10, receiving signals from components of mobile sprayer 10, providing control signals to components of mobile sprayer 10, gathering data, processing data, etc. Sprayer controller 28 can include hardware, firmware, and/or stored software, and sprayer controller 28 can be entirely or partially mounted on one or more circuit boards. Sprayer controller 28 can be of any type suitable for operating in accordance with the techniques described herein.

Control circuitry 50, in one example, is configured to implement functionality and/or process instructions. For example, control circuitry 50 can be capable of processing instructions stored in memory 52. Examples of control circuitry 50 can include one or more of a processor, a microprocessor, a controller, a digital signal processor (DSP), an application specific integrated circuit (ASIC), a field-programmable gate array (FPGA), a graphics processing unit (GPU), a system-on-module (SOM), or other equivalent discrete or integrated logic circuitry. Control circuitry 50 can be entirely or partially mounted on one or more circuit boards.

Memory 52 can be configured to store information before, during, and/or after operation. Memory 52, in some examples, is described as computer-readable storage media. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, memory 52 is a temporary memory, meaning that a primary purpose of memory 52 is not long-term storage. Memory 52, in some examples, is described as volatile memory, meaning that memory 52 does not maintain stored contents when power to sprayer controller 28 is turned off. Examples of volatile memories can include random access memories (RAM), dynamic random access memories (DRAM), static random access memories (SRAM), and other forms of volatile memories. In some examples, memory 52 is used to store program instructions for execution by control circuitry 50. Memory 52, in one example, is used by software or applications to temporarily store information during program execution.

Memory 52, in some examples, also includes one or more computer-readable storage media. Memory 52 can be configured to store larger amounts of information than volatile memory. Memory 52 can further be configured for long-term storage of information. In some examples, memory 52 includes non-volatile storage elements. Examples of such non-volatile storage elements can include magnetic hard discs, optical discs, flash memories, or forms of electrically programmable memories (EPROM) or electrically erasable and programmable (EEPROM) memories, among other options.

The memory 52 can store program instructions executable by the one or more processors for receiving information from, and delivering power to, any of the components referenced and/or shown herein to perform any of the functions referenced herein. For example, the control circuitry 50 can receive information from the sensors 30, such as information concerning the distance to a wall, orientation relative to the wall, and location of a distance to features along the wall about which the mobile sprayer 10 needs to navigate and possibly spray. Based on information received from the sensors 30, the control circuitry 50 can regulate output of electrical power to the drive motors 22 to maneuver and orientate the mobile sprayer 10 relative to the wall to be sprayed. The control circuitry 50 can regulate output of electrical power to the movement motors 24 to control the vertical position of the at least one spray module 20. The control circuitry 50 can provide and regulate output of electrical power to the at least one spray module 20 to control release of paint from the spray module 20. For example, spray module 20 may contain a solenoid that can be electrically activated to open and/or close a needle valve with the spray module 20 which controls release of paint from the spray nozzle 44.

In various examples, the control circuitry 50 does not directly control the electric pump motor 90 within the pump module 86. Rather, the pump module 86 can include a pump sensor which senses the pressure of the paint output by the pump 88 of the pump module 86 and compares the measured pressure to a threshold. If the pressure falls below the threshold, pump controller 98 of just the pump module 86 can supply power to the electric pump motor 90 of the pump module 86 to operate the piston pump 88 to resume pumping paint until the pressure exceeds the threshold, in which case the pump controller 98 of just the pump module 86 can cause the electric pump motor 90 to cease operating the pump 88 of the pump module 86. The release of paint from the spray module 20 causes the pressure of the paint to drop, triggering the pump module 86 to resume pumping. Thus, the sprayer controller 28 can control the solenoid of the spray module 20 to start spraying which reduces pressure which causes the pump module 86 to resume pumping until the sprayer controller 28 instructs the spray module 20 to cease spraying which causes the pressure to rise and the pump module 86 to cease pumping. As such, sprayer controller 28 may not directly control the pump module 86, but can indirectly cause the pump module 86 to pump and cease pumping based on measured pressure of the paint being fed to the spray module 20 which flow of paint to and through the spray module 20 is directly controlled by the sprayer controller 28.

Power module 32 can provide electrical power to up to all electric components of mobile sprayer 10. The power module 32 can be located on the mobile sprayer 10. For example, the power module 32 can be mounted on the base 36. The power module 32 can be a battery, such as a high-capacity lithium-ion battery that supplies electrical energy to the assembly controller. Such electrical energy can be used to power the movement motor 24, the drive motors 22, and the spray module 20, as well as the interface 34 and the sensors 30. As discussed above, however, some examples are configured such that the electrical energy that powers components of mobile sprayer 10 does not power the pump module 86. It can be advantageous to have a dual battery system (e.g., including pump battery 92a and sprayer battery 94b) in which the pump module 86 is powered by a pump battery 92a whereas all other electrical components are powered by a sprayer battery 94b. For example, the pump module 86 can have its own dedicated pump battery 92a which stays with the pump module 86 even when the pump module 86 is dismounted from the mobile sprayer 10. Moreover, high-capacity sprayer battery 94b can be located internally and can be charged for long-duration use, such as for a day; whereas the pump battery 92a for the pump module 86 can be exchanged throughout the day depending on pump demands and/or swapped amongst other painting equipment being used on the jobsite. While the separate power sources are described as batteries, it is understood that not all examples are so limited. For example, one or both of the mobile sprayer 10 and pump module 86 can include a power cord configured to plug into an electrical wall socket to receive power.

Lateral midline ML is indicated in FIG. 5, which midline ML extends through the leading side 58 and trailing side 60. The lateral midline ML extends laterally. The midline ML can be considered to be the midpoint between the wall-facing side 56 and the outward side 62. The midline ML can, in some examples, extend over a center of gravity of mobile sprayer 10. In the example shown, while the mobile sprayer 10 is navigated along the wall to spray a plurality of vertical or horizontal swaths on the wall, the mobile sprayer 10 travels along the indicated midline ML. The portion of mobile sprayer 10 between midline ML and wall-facing side 56 can be considered to form an inboard portion of mobile sprayer 10. The portion of mobile sprayer 10 between midline ML and outward side 62 can be considered to form an outboard portion of mobile sprayer 10.

Longitudinal midline LM is indicated in FIG. 4, which midline LM extends through the wall-facing side 56 and the outward side 62. The longitudinal midline extends longitudinally. The midline LM can be aligned with a spray axis SA along which the nozzle 44 of the spray module 20 is configured to output the spray fluid. The portion of mobile sprayer 10 between midline LM and leading side 58 can be considered to form a leading or forward portion of mobile sprayer 10. The portion of mobile sprayer 10 between midline LM and trailing side 60 can be considered to form a rearward or trailing portion of mobile sprayer 10. The forward portion can be forward of the nozzle 44 and spray module 20. The rearward portion can be rearward of the nozzle 44 and spray module 20.

Reservoir support 16 and pump support 18 are disposed rearward of the nozzle 44 and spray module 20 such that reservoir 64 and pump module 86 are located on the trailing side end of the mobile sprayer 10. In particular, each of the reservoir 64 and the pump module 86 are located along the trailing side 60. Reservoir 64 is located in the corner formed between the trailing side 60 and the wall-facing side 56. The pump module 86 is located in the corner formed between the trailing side 60 and the outward side 62. Disposing pump module 86 in the corner between trailing side 60 and outward side 62 can position pump module 86 away from the target surface 54 and thus away from any overspray that may be produced during spraying, protecting the pump module 86, which can include electrical components. Alternatively, the spray module 20 can be located in the corner formed between the trailing side 60 and the wall-facing side 56 while the reservoir 64 can be located in the corner formed between the trailing side 60 and the outward side 62. In some additional or alternative examples, one of the reservoir 64 and the pump module 86 can be located in the trailing portion of the base 36 and the other one of the reservoir 64 and the pump module 86 can be located in the leading portion of the base 36.

Reservoir support 16 is at least partially disposed over a first base area of the base 36 formed between the spray module 20 and the trailing side 60 and between a first one of the outward side 62 and the wall-facing side 56 and the lateral midline. The pump module 86 can be at least partially disposed over a second base area of the base 36 formed between the spray module 20 and the trailing side 60 and between a second one of the outward side 62 and the wall-facing side 56 and the lateral midline.

Locating the pump module 86 and the reservoir 64 in such a configuration allows these components to be accessed relatively easily during operation of the mobile sprayer 10 (e.g., for adjusting the pump module 86, changing the pump battery 92, or adding paint to the reservoir 64). The pump module 86 and the reservoir 64 can be mounted such that one or both of pump module 86 and reservoir 64 are exposed and not covered by the frame 12. Further, the pump module 86 and reservoir 64 can be located outside of the sensing envelope of the sensors 30. Locating these components on the leading side 58 is not ideal because the sensors 30 are generally pointed forward searching for obstacles and a person in this area would cause halting of operation of the mobile sprayer 10. The reservoir 64 and the pump module 86 can be relatively heavy components, such that placing them on opposite sides of the midline ML (e.g., with one in the inboard portion and one in the outboard portion) can help balance the distribution of weight of the mobile sprayer 10. The user can approach reservoir 64 and refill reservoir 64 while mobile sprayer 10 operates, such that mobile sprayer 10 can continuously operate so long as reservoir 64 is refilled. Mobile sprayer 10 does not have to stop spray operations during filling of reservoir 64, increasing the efficiency of spray operations and reducing downtime.

In various examples, a user can use the interface 34 to input a spray parameter to control the operation of the mobile sprayer 10 to spray a specified coating thickness. For example, a user can input a coating thickness, typically measured in thousandths of an inch, known as “mils”. For example, a user can set a mil amount via the interface 34 and the sprayer controller 28 can determine a displacement speed for spray module 20 to cause application of the spray fluid at the desired mil thickness. For example, sprayer controller 28 can use a look-up table, index, plot, among other options to determine the speed at which the spray module 20 should move to achieve the specified mil amount. Generally, the slower the movement of the spray module 20, such as along vertical paths for applying vertical swaths, the thicker the coating; whereas the faster the movement of the spray module 20, the thinner the coating. As such, the higher the input mil parameter, the slower the sprayer controller 28 will cause the spray module 20 to move while the lower the input mil parameter the faster the sprayer controller 28 will cause the spray module 20 to move.

The sprayer controller 28 can be configured to control operation of various components of mobile sprayer 10 to cause the mobile sprayer 10 to apply the spray coating according to the target mil thickness. In some examples, the sprayer controller 28 is configured to control displacement of each of the elevator 26, mast 38, and nozzle actuator 96 to set a displacement speed of the spray module 20 for applying at the target mil thickness.

In some examples, sprayer controller 28 is configured to adjust the displacement operations of the various movement motors 24 associated with the spray nozzle 44 based on a set spray height from the mobile sprayer 10. The mobile sprayer 10 can be configured such that spray nozzle 44 displaces at a nozzle speed that is a combination of multiple discrete displacement speeds of components of mobile sprayer 10. For example, the elevator 26 can displace along the mast 38 to displace the spray module 20 vertically. The upper mast 40 can also displace relative to the lower mast 42 such that the spray module 20 moves at a nozzle displacement speed relative to the target wall surface that is greater than the individual driven displacement speed of the elevator 26 or upper mast 40. Further, spray nozzle 44 can be reoriented during spraying, such as by pivoting, which reorientation also affects the relative displacement speed of the spray nozzle 44, thereby also affecting deposition thickness of the spray material on the wall surface.

Sprayer controller 28 can be configured to control the individual displacements of various components of mobile sprayer 10 to achieve the desired deposition thickness on the target surface. The sprayer controller 28 can receive a thickness command. For example, the user can input the thickness command to the sprayer controller 28 via the interface 34. The sprayer controller 28 can also receive a height command in various examples. The height command provides an upper vertical limit for spraying of the spray fluid to sprayer controller 28. The sprayer controller 28 can be configured to cause the spray nozzle 44 to stop release of spray fluid when the spray of spray fluid reaches the upper vertical limit. For example, the sprayer controller 28 can stop the release of spray fluid based on spray module 20 reaching the upper vertical limit, or the spray reaching the upper vertical limit such as due to reorienting of the spray nozzle 44, etc.

Sprayer controller 28 can, in some examples, cause pump module 86 to activate to drive pressurized spray fluid to the spray module 20. The sprayer controller 28 causes the spray valve 46 to open and causes spray valve 46 to close, thereby controlling spraying through the nozzle 44. Spray module 20 is configured to displace vertically away from and towards the base 36. For example, the sprayer controller 28 can be communicatively connected to pump motor 90, such as directly to pump motor 90 and/or via pump controller 98. The sprayer controller 28 can be configured to control one or both of the pressure of the spray fluid output from pump 88 and the nozzle displacement rate for the spray nozzle 44 to control the deposition thickness. In some examples, sprayer controller 28 is not communicatively connected to pump module 86. In such an example, the sprayer controller 28 can control the nozzle displacement rate for the spray nozzle 44 to control the deposition thickness. In some examples, the sprayer controller 28 can control the deposition thickness by setting the nozzle displacement speed based on the thickness input from the interface 34 and a pressure of the spray fluid downstream of the pump 88, as such pressure can affect the volume of fluid output through nozzle 44.

In some examples, the sprayer controller 28 controls the displacement speed of a single component (e.g., elevator 26) to control the nozzle displacement rate. In some examples, the sprayer controller 28 can control the displacement speeds of multiple components of mobile sprayer 10 that are individually actuatable and displaceable relative to each other (e.g., elevator 26, upper mast 40, reorienting of nozzle 44).

In some examples, the sprayer controller 28 is configured to control individual displacement speeds of multiple vertically displaceable components to maintain a displacement speed of nozzle 44. For example, sprayer controller 28 can control the individual displacement speeds of the elevator 26 and the upper mast 40. The sprayer controller 28 can be configured to control the individual displacement speeds of the vertically displaceable components by controlling the output speeds of movement motors 24 that displace the vertically displaceable components. In the example shown, the sprayer controller 28 can control the vertical displacement speed of upper mast 40, which speed can be referred to as a mast speed, and can control the vertical displacement speed of elevator 26, which speed can be referred to as an elevator speed.

Sprayer controller 28 can control both the elevator speed and the mast speed to maintain a desired nozzle speed corresponding to the desired deposition thickness. The sprayer controller 28 can control elevator motor 82 and mast motor 84 to adjust the relative speeds of one or both of the elevator 26 and upper mast 40 to maintain the nozzle 44 at the desired nozzle speed for the commanded deposition rate. For example, at the beginning of an upward vertical stroke, the sprayer controller 28 can cause the elevator 26 to displace at a first elevator speed, which can be equivalent to the desired nozzle speed in some examples.

The spray module 20 displaces vertically due to elevator 26. If the upper vertical limit is above the top end of lower mast 42, then sprayer controller 28 can activate mast motor 84 to cause upper mast 40 to displace and elevate relative to lower mast 42. The sprayer controller 28 can cause the upper mast 40 to begin to displace at a first mast speed. The sprayer controller 28 can cause the elevator 26 to decrease speed as the upper mast 40 increases speed to maintain the nozzle 44 displacing at the desired nozzle speed. The sprayer controller 28 can cause one of mast motor 84 and elevator motor 82 to accelerate and the other to decelerate to maintain the spray nozzle 44 at the desired nozzle displacement speed. In some examples, the sprayer controller 28 can cause the elevator 26 or upper mast 40 to first displace to an end of travel for that component and can then cause the other one of the elevator 26 and upper mast 40 to move along its displacement length at the same speed as the first component to maintain the nozzle displacement speed. The sprayer controller 28 can, in some examples, simultaneously cause the mast motor 84 and elevator motor 82 to move and can change the elevator speed and the mast speed relative to each other without causing a change in the nozzle displacement speed.

During such operation the elevator 26 can continue to rise along the mast 38 as the upper mast 40 displaces relative to lower mast 42. The nozzle 44 is thus displacing at a nozzle displacement speed that is a combination of the elevator speed and the mast speed. The sprayer controller 28 can control the deposition thickness by controlling the nozzle displacement speed of the nozzle 44. The sprayer controller 28 controls displacement speeds of both the elevator 26 and the upper mast 40 to maintain a constant nozzle displacement speed throughout the swath to maintain an even deposition thickness.

The sprayer controller 28 can be configured to operate in a first spray mode in which the elevator speed is set to a first speed equal to or less than the nozzle displacement speed and in a second spray mode in which elevator speed is set to a second speed less than the first speed. In the first spray mode the mast speed can be set to zero such that the upper mast 40 is stationary. In the second spray mode the mast speed can be greater than zero. The sprayer controller 28 can be configured to operate in one of the first spray mode and the second spray mode prior to the other one of the first spray mode and the second spray mode during vertically upward displacement of the nozzle 44. The sprayer controller 28 can be configured to operate in the other one of the first spray mode and the second spray mode prior to the one of the first spray mode and the second spray mode during vertically downward displacement of the nozzle 44. The sprayer controller 28 can be configured to operate in the first spray mode prior to the second spray mode during vertically upward displacement of the nozzle 44. The sprayer controller 28 can be configured to operate in the second spray mode prior to the first spray mode during vertically downward displacement of the nozzle 44.

In additional or alternative examples, the sprayer controller 28 is configured to control displacement of nozzle 44 between multiple orientations relative to the target surface 54 to maintain the nozzle displacement speed and thus the deposition rate.

The nozzle 44 can also be configured to reorient during spraying, as discussed above. In some examples, the nozzle 44 can reorient from oriented downward at the beginning of an upward vertical swath to upward at the end of an upward vertical swath. Nozzle 44 can be reoriented between a downward angled orientation and an upward angled orientation as nozzle 44 vertically traverses relative to the target surface 54. The reorienting of the nozzle 44 affects the nozzle displacement speed. During the upward vertical swath, the upward reorientation of the nozzle 44 works in the same direction to elevator 26 and mast 38 displacement such that the reorienting effectively increases the nozzle displacement speed. The sprayer controller 28 can control the nozzle actuator 96 to control reorienting of the nozzle in addition to the vertical displacement speed of the spray module 20 to set the nozzle displacement speed. In some examples, the sprayer controller 28 is configured to control the displacement speed of a vertical displacer, such as one or both of elevator 26 and mast 38 in the example shown, and is further configured to control the reorientation speed of the nozzle 44 to set the actual nozzle displacement speed. For example, if nozzle 44 is oriented at the downward tilt orientation at the bottom end of a swath, the sprayer controller 28 can control the speed at which nozzle 44 reorients (e.g., pivots) and the speed at which nozzle 44 is carried vertically (e.g., by elevator 26 and/or upper mast 40) to set and maintain the vertical displacement speed of the nozzle 44 thus maintaining a constant deposition thickness. For example, nozzle 44 can begin to tilt upward from the downward tilt orientation as elevator 26 moves spray module 20 upward. In such an example, the reorientation adds to the nozzle displacement speed. Sprayer controller 28 can relatively decrease the vertical carry speed of one or both of upper mast 40 and elevator 26 to compensate for the reorientation speed of the nozzle 44.

At least some of the relative displacement speeds controlled by sprayer controller 28 to maintain the nozzle displacement speed steady can be set based on other operating parameters of the mobile sprayer 10. For example, the user can provide a set spray height to mobile sprayer 10 that sets the upper limit for spraying. Sprayer controller 28 can, in some examples, be configured to set a reorientation speed of the spray nozzle 44 based on the set spray height. For example, sprayer controller 28 can be configured to cause nozzle 44 to continuously reorient between the downward and upward tilt orientations as the spray module 20 traverses between the upper and lower travel limits set based on the set spray height. In such an example, the reorientation speed for nozzle 44 is going to increase as the set spray height decreases and the reorientation speed for nozzle 44 is going to decrease as the set spray height increases. The sprayer controller 28 can be configured to set the nozzle reorientation speed based on the user supplied operating parameter and can be configured to control the speeds of the various vertical displacers based on the set spray height and the set nozzle reorientation speed. In some examples, the nozzle reorientation speed can be maintained steady and the displacement speeds of the vertical displacers can be varied to maintain the nozzle displacement speed steady.

The sprayer controller 28 can be configured to set the nozzle displacement speed based on a desired deposition thickness indicated by the user. In some examples, the user can input additional operating parameter information to the sprayer controller 28 for controlling the deposition thickness via interface 34. For example, the operating parameters can be input to sprayer controller 28 via interface 34 and/or can be provided to sprayer controller 28 via one or more sensors (e.g., a pressure transducer configured to sense pressure downstream of pump 88). For example, the sprayer controller 28 can determine a target nozzle displacement speed based on one or more of a spray fluid pressure (e.g., either as input by the user or sensed by a pressure transducer); nozzle 44 configuration information (e.g., the size and shape of the nozzle 44); fluid information (e.g., material type, temperature, etc.); among other operating parameter information.

In some examples, a deposition thickness database can be generated and stored in memory 52 of sprayer controller 28. The deposition thickness database can store information regarding anticipated thicknesses given certain operating parameters, such as an anticipated deposition rate for a certain material sprayed at a certain pressure though a certain spray tip, etc. The sprayer controller 28 can recall anticipated deposition thickness information from the deposition thickness database and can control movement of various movement motors 24 of mobile sprayer 10 during spraying of a fluid swath to maintain the nozzle 44 at a nozzle deposition speed associated with the desired deposition thickness.

In some examples, the sprayer controller 28 is configured to control the nozzle displacement speed based on a unitless input from the user. For example, the user can provide information via interface 34, such as by rotating a dial, moving a slider, etc., to cause mobile sprayer 10 to output a thinner or thicker coating of the spray material. In such an example, the sprayer controller 28 can cause the nozzle displacement speed to increase based on the input indicating a desire for thinner coverage and the sprayer controller 28 can cause the nozzle displacement speed to decrease based on the input indicating a desired for thicker coverage.

For example, the interface 34 can include a thickness dial. The dial can be actuatable between a first range end and a second range end. The first range end can correspond with a first speed of the nozzle and the second range end can correspond with a second speed of the nozzle. The first speed can be a minimum operational speed of the nozzle 44. The second speed can be a maximum operational speed of the nozzle 44. The user twisting the dial in a first direction away from the first range end and towards the second range end can cause the sprayer controller 28 to increase the nozzle displacement speed, providing for thinner coverage. The user twisting the dial in a second, opposite direction away from the second range end and towards the first range end can cause the sprayer controller 28 to decrease nozzle displacement speed, providing for thicker coverage.

In some examples, the sprayer controller 28 is configured to vary the nozzle displacement speed linearly based on the thickness input to the interface 34. The sprayer controller 28 can vary the nozzle displacement speed linearly based on a position of the interface 34 between the first range end and the second range end. For example, placing the interface 34 at a midpoint between the first range end and the second range end can cause the nozzle displacement speed to be set at a midpoint between the first speed and the second speed.

The sprayer controller 28 maintaining spray nozzle 44 at a steady displacement speed during operations provides significant advantages. The pump module 86 is configured to output the spray fluid such that a pressure of the spray fluid is maintained as the spray fluid is atomized through spray nozzle 44. The steady pressure generates a steady state flow of the spray fluid through the spray nozzle 44. Such a flow has a known flow rate. The flow rate and displacement speed of the spray nozzle 44 provide the deposition rate and thus the deposition thickness of the spray material on the target surface 54.

In typical spraying operation, vertical swaths are applied in an overlapped configuration in which adjacent swaths at least partially overlap each other to provide multiple coatings to the target surface 54. In most spray operations, the vertical swaths overlap each other by 50-percent such that each area on the wall is sprayed twice. The sprayer controller 28 is configured to manage movement of the mobile sprayer 10 between spraying of each swath to get as close to 50-percent overlap as practically possible. Such movement and reorientation of the mobile sprayer 10 requires calculation of the travel distance for the spraying of each swath which will be sprayed to overlap the previously sprayed swath and which itself will be overlapped partially with the spraying of the next swath.

In some examples, to set and control for such travel distance between swaths, the user may determine the preferred distance from the spray nozzle 44 to the wall for spraying. Differences in spray nozzles 44, different types of spray fluid, and different preferred wall finishes will influence how closely or far away the user wants the spray nozzle 44 to be relative to the wall when spraying the wall. The user can then cause the mobile sprayer 10 to position the spray nozzle 44 with such separation distance, such as by inputting the separation distance into the interface 34 or by inputting other commands that cause the mobile sprayer 10 to move. In some examples, the sprayer controller 28 can determine a distance from the nozzle 44 to the wall based on information provided by sensors 30.

In some examples, to set and control for such travel distance between swaths, the sprayer controller 28 is configured to set the separation distance. In some examples, the sprayer controller 28 is configured such that the separation distance is determined to be acceptable when the sensed separation distance, such as based on information from sensors 30, is within a distance range between maximum and minimum separation distances. In some examples, the separation distance is preset and stored in memory 52 and sprayer controller 28 is configured to position mobile sprayer 10 based on the preset separation distance.

In some examples, the mobile sprayer 10 can then be caused to spray a burst of spray fluid to test the landing fan width of the spray pattern on the wall. The fan width can be measured and input to sprayer controller 28. For example, the user can measure the fan width (e.g., with a tape measure) and input such measured fan width into the interface 34. In some examples, one or more of sensors 30 comprise a vision system of the mobile sprayer 10 configured to optically recognize and measure the fan width. In such an example, the sprayer controller 28 can determine the actual fan width based on the spray fluid actually output by mobile sprayer 10.

Based on the measured fan width, the sprayer controller 28 can then determine a travel distance for the mobile sprayer 10 to travel between the spraying of each adjacent vertical swath. For example, sprayer controller 28 can calculate the travel distance as one half of the measured fan width for applying a 50-percent overlap. In this way, the sprayer controller 28 can cause the spraying of a first vertical swath while the base 36 is stationary, after the spraying of the first vertical swath, the sprayer controller 28 can cause the mobile sprayer 10 to move laterally along the wall by the travel distance (e.g., one half of the fan width). After having traveled the travel distance, the sprayer controller 28 can cause a mobile sprayer 10 to spray a second vertical swath that will overlap with the first vertical swath by 50-percent. While a 50-percent overlap is discussed herein by way of example, it is understood that mobile sprayer 10 can be configured for any desired overlap amount. For example, the sprayer controller 28 can determine the travel distance based on the fan width information and an overlap parameter. The overlap parameter can set the amount of overlap between adjacent fluid swaths. The overlap parameter can be based on an overlap setting stored in memory 52, such as a 50-percent overlap setting, or can be provided by the user, such as via interface 34.

In some examples, the sprayer controller 28 can be configured to determine an anticipated fan width based on one or more operating parameters input to sprayer controller 28. For example, the operating parameters can be input to sprayer controller 28 via interface 34 and/or can be provided to sprayer controller 28 via one or more sensors (e.g., a pressure transducer configured to sense pressure downstream of pump 88). For example, the sprayer controller 28 can determine the anticipated fan width based on one or more of a spray fluid pressure (e.g., either as input by the user or sensed by a pressure transducer); nozzle information (e.g., the size and shape of the nozzle 44); fluid information (e.g., material type, temperature, etc.); among other operating parameter information.

In some examples, a fan width database can be generated and stored in memory 52 of sprayer controller 28. The fan width database can store information regarding anticipated fan widths given certain operating parameters, such as an anticipated fan width for a certain material sprayed at a certain pressure though a certain spray tip, etc. The sprayer controller 28 can recall anticipated fan width information from the fan width database and can control movement of the mobile sprayer 10 between adjacent swaths based on the anticipated fan width determined by sprayer controller 28.

When spraying straight sections along the wall comprising a plurality of vertical swaths while operating in a first mode for spraying straight sections of the wall, the mobile sprayer 10 will inevitably approach a transition in the wall, such as a corner. Typically, the mobile sprayer 10 will recognize the type of transition and execute the program for a second mode for traversing and possibly spraying the transition, which may include multiple pivoting and spraying operations as previously described and as discussed in International Application No. PCT/US2020/0663262. Such second mode is distinguished from the first mode in that pivoting in the second mode is required to reorientate the mobile sprayer 10 about a corner or other transition, whereas pivoting is avoided in the first mode and is typically only done to correct inadvertent changes in orientation.

Before transitioning to the second mode, the sprayer controller 28 will decide whether to spray one extra vertical swath, which can be referred to as a coverage swath or an additional swath, to provide overlap coverage with the last vertical swath of the plurality of vertical swaths that have already been sprayed with mobile sprayer 10 operating in the first mode. The decision on whether or not to spray the coverage swath before operating in the second mode can be based on a distance. The distance can be the distance between the location of the last vertical swath of the plurality of vertical swaths and a location of the transition. The distance can be based on a length along the wall between the location of the spray module 20 as it sprayed the last vertical swath of the plurality of vertical swaths and a closest edge of the transition. Such distance can be calculated, such as based on distance information from sensors 30, and compared to a coverage threshold. The coverage threshold may be half of the movement distance that the mobile sprayer 10 moves between vertical swaths when in the first mode. For example, if the remaining distance is less than half of the movement distance, then the mobile sprayer 10 transitions to the second mode (including pivoting at least twenty-degrees in some examples) without spraying an additional coverage swath. If the remaining distance is greater than half the movement distance, than the mobile sprayer 10 sprays the coverage swath before entering the second mode, or otherwise pivoting greater than twenty-degrees.

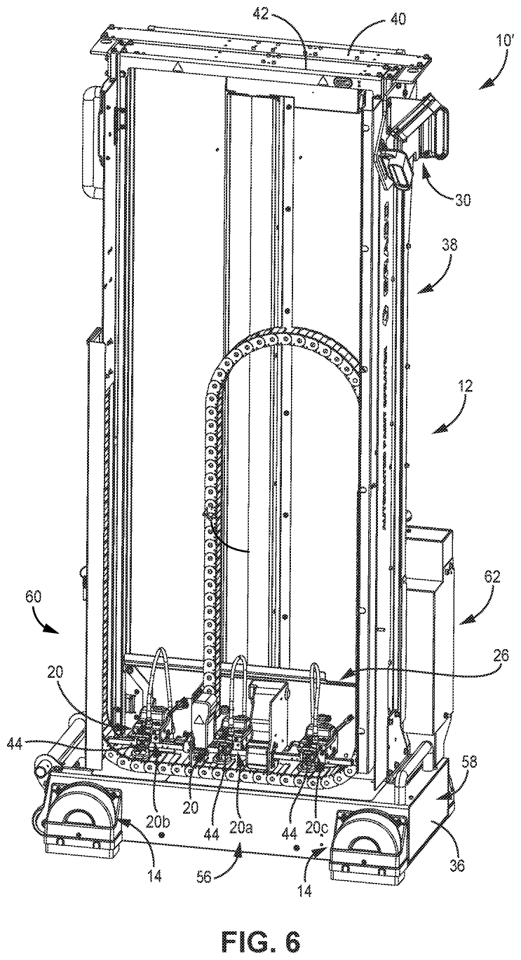

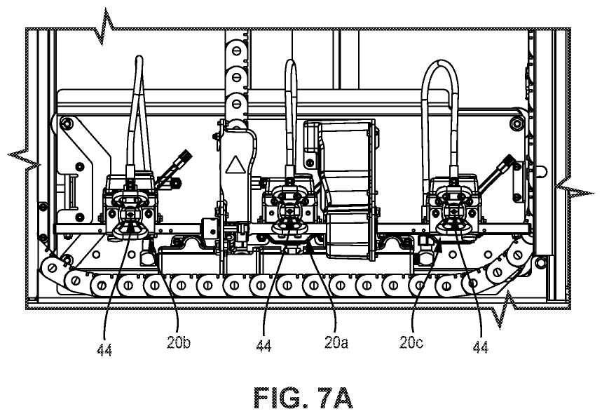

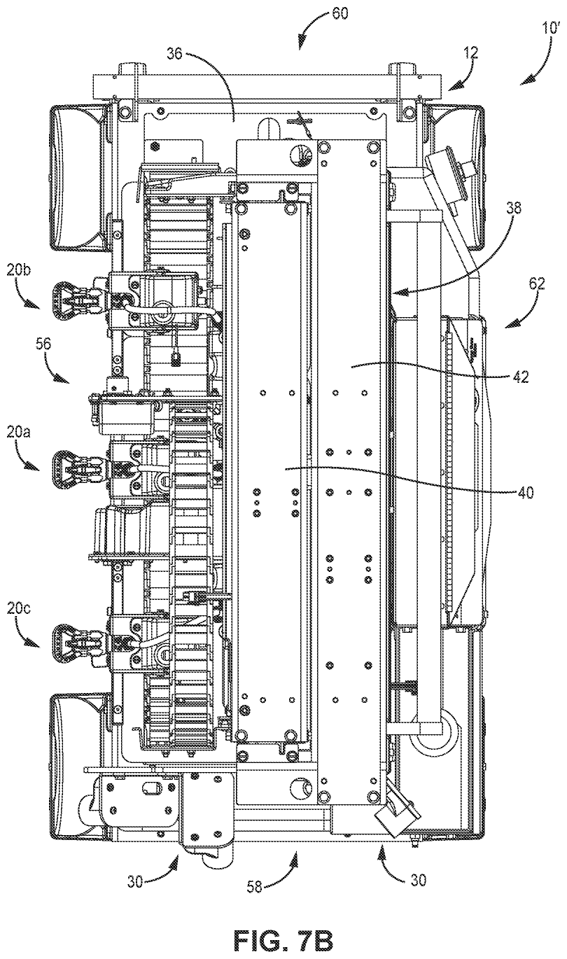

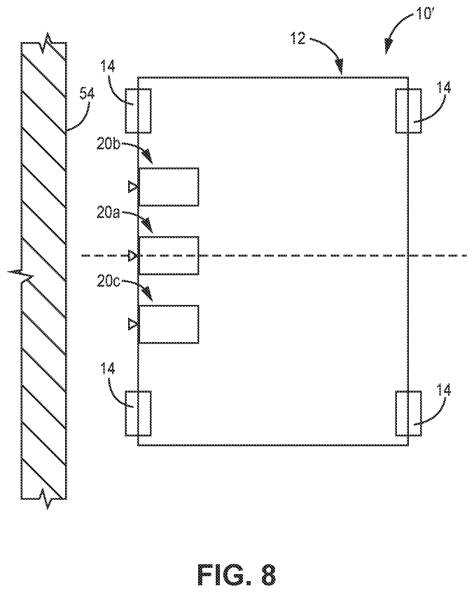

FIG. 6 is an isometric view of a mobile sprayer 10′. FIG. 7A is an enlarged elevational view showing spray modules 20 of mobile sprayer 10′. FIG. 7B is an enlarged top view showing spray modules 20 of mobile sprayer 10′. FIG. 8 is a top block diagram of mobile sprayer 10′. FIGS. 6-8 are discussed together. Mobile sprayer 10′ is substantially similar to mobile sprayer 10 (best seen in FIGS. 1A-3B) except that mobile sprayer 10′ includes multiple spray modules 20.

In the example shown, mobile sprayer 10′ includes spray modules 20a-20c (collectively herein “spray module 20” or “spray modules 20”). While mobile sprayer 10′ is shown as including three spray modules 20, it is understood that not all examples are so limited. For example, mobile sprayer 10′ can include two, three, four, five, or more spray modules 20. The spray modules 20a-20c are configured to move up and down the elevator 26 together, and spray in synchrony or at different times, as further discussed herein. Each spray module 20a-20c includes a respective spray nozzle 44. Each spray module 20a-20c is positioned to spray out from the wall-facing side 56 of the mobile sprayer 10′.

Multiple spray modules 20 can be useful for performing high productivity spraying. For example, multiple spray nozzles 44 can output more paint on the wall during application of each spray swath, and lateral separation between the spray nozzles 44 can cover more area in each vertical swath is sprayed.

In some examples, the sprayer controller 28 can be configured to actively control spraying by each of the multiple spray modules 20. In some examples, the multiple spray modules 20 can be activated at the same time to spray while the spray modules 20 are raised or lowered simultaneously by the elevator 26. In some examples, one or more of the modules 20 can be configured to spray simultaneously while others of the spray modules 20 do not emit fluid spray. The respective spray fans output by the spray nozzles 44 may overlap or may abut but not overlap each other when the spay fluid impacts the target surface 54.

In some examples, the mobile sprayer 10′ includes multiple pump modules 86 that are each operatively associated with a single spray module 20. In some examples, mobile sprayer 10′ includes one or more pump modules 86 that are operatively connected to multiple spray modules 20 to provide spray fluid to the multiple spray modules 20. In some examples, the mobile sprayer 10′ includes a single pump module 86 that supplies pressurized spray fluid to each spray module 20.

In some examples, the multiple spray modules 20 can be grouped into operational module groupings. The module groups can be controlled as units. For example, each spray module 20 within an module group can be controlled to displace and/or spray simultaneously. In some examples, all spray modules 20 are displaced vertically, such as by elevator 26 and/or upper mast 40, together while the spray modules 20 are controlled as the module groups.

In some examples, the outer spray modules 20b, 20c are paired as a first module group while the middle spray module 20a is used individually and can be considered to form its own second module group. For high production spray work along a straight wall, it may be advantageous to spray with the multiple spray modules 20 of the first group to get wider coverage for each vertical swath sprayed. However, such wide coverage may not be advantageous for spraying transitions in the wall. Such a transition can be a change in angle of the wall, a corner of the wall (e.g., 90-degree corner of a room or a 180-degree entry into an adjacent room), a bump out in the wall, a window in the wall, a doorway in the wall, or other irregular structure in a section of the wall that is different from a broad, straight section of the wall. During such a transition, the sprayer controller 28 can command the drive motors 22 to re-orientate the mobile sprayer 10′ relative to the wall between spraying vertical swaths. For example, when spraying a corner, the mobile sprayer 10′ can turn in degree increments (e.g., at least 20-degrees, 30-degrees, 45-degrees, among other options) between spraying vertical swaths. The spray volume from multiple spray nozzles 44 may be too much and too wide for a transition, such that spraying from a single nozzle 44 is preferred. In such an example, the sprayer controller 28 can cause the spray module 20a to apply swaths of spray fluid when transitioning. As such, the mobile sprayer 10′ can transition between spraying using multiple nozzles 44 (e.g., of spray modules 20b, 20c) for broad straight areas along the wall and using a single nozzle 44 (e.g., of spray module 20a) when spraying transitions in the wall. The sprayer controller 28 can control the module groups such that the outer module group is not activated to spray transition sections of the wall which are not straight while the central module group is not activated to spray straight sections of the wall.

It is understood that mobile sprayer 10′ can be configured to determine a lateral displacement distance based on the spray width of the spray swath from the module group applying the spray fluid. For example, the module group including the outer spray modules 20b, 20c can be configured such that there is a dual overlap zone formed by an overlap between the spray fans emitted by the outer spray modules 20b, 20c.

In some examples, mobile sprayer 10′ is positioned relative to the surface 54 such that the dual overlap zone includes 50-percent of the width of each spray fan, providing for a 50-percent overlap and double coating per spray pass in the dual overlap zone. After applying a single vertical swath of the spray fluid, the sprayer controller 28 can cause the mobile sprayer 10′ to shift such that the trailing edge of a next swath applied by the module group including the spray modules 20b, 20c is aligned with a leading edge of the dual overlap zone of the adjacent and already applied single vertical swath. The sprayer controller 28 can cause the mobile sprayer 10′ to apply swaths such that the new swath does not coat within the dual overlap zone of the previously applied swath but does overlap with the portion of the previous swath between the leading end of the previously applied dual overlap zone and the leading edge of that previous swath. In such an example, the sprayer controller 28 can cause the mobile sprayer 10′ to shift relative to the surface 54 by a distance equivalent to 1.5 fan widths of the spray fan emitted by the pair of nozzles 44 of spray modules 20b, 20c or equivalent to ⅔ of the width of the spray swath from the module group including the outer spray modules 20b, 20c.

In some examples, the nozzles 44 of the outer spray modules 20b, 20c can be angularly offset relative to each other. For example, one of spray modules 20b, 20c can be tilted slightly upward or downward relative to the other one of spray modules 20b, 20c. In some examples, both spray modules 20b, 20c can be slightly offset. For example, one spray module 20b, 20c can angled to spray upward and one spray module 20b, 20c can be angled to spray downward. Such angular offset misaligns the spray fans emitted by the outer spray modules 20b, 20c to prevent the sprays from colliding when spraying from both of the outer spray modules 20b, 20c simultaneously and when the spray patterns overlap to provide dual coating on the surface.

In examples in which the spray fans emitted by the outer spray modules 20b, 20c do not overlap, the sprayer controller 28 can cause the mobile sprayer 10′ to shift such that the trailing spray module 20c is aligned with the portion of the surface 54 previously coated by the leading spray module 20b when applying the previous, adjacent swath. In such an example, the sprayer controller 28 can cause the mobile sprayer 10′ to shift relative to the surface 54 by a distance equivalent to a single fan width of one of the nozzles 44 of the outer module group or equivalent to half of the width of the spray swath from the outer module group.

In some examples, mobile sprayer 10′ is configured such that a first spray module 20 can spray during both multi-nozzle operations and single nozzle operations. In some other examples, a second spray module 20 used in multiple and single nozzle operations sprays in either the multi-nozzle operation or the single nozzle operation, but not both. In some examples, the module groups do not spray while the other module group is spraying.

In some examples, the spray module 20a can be used for spraying transition sections of the wall whereas the outer spray modules 20b, 20c can be used for broad, straight sections of the wall. In some examples, the central spray module 20a is configured to emit spray fluid during both multi-nozzle operations and single nozzle operations. In some examples, the spray modules 20 are configured such that the spray fan emitted by the central spray module 20a overlaps with the spray fans emitted by both the outer spray modules 20b, 20c. In some such examples, the spray fans emitted by the outer spray modules 20b, 20c do not overlap, such that each spray fan overlaps with only one other spray fan and/or with no other spray fans at each location across the width of the spray swath. In such an example, the spray fan of the spray module 20a can overlap with multiple other spray fans while the spray fans of the outer spray modules 20b, 20c each overlap with only one other spray fan. In such an example, the dual overlap zone can be the width of the spray fan from the central spray module 20a.

In some examples, the spray modules 20 are configured such that a nozzle 44 of the spray module 20a can be configured to output a first spray fan having a first fan width. A nozzle 44 of the spray module 20b can be configured to output a second spray fan having a second fan width. A nozzle 44 of the spray module 20c can be configured to output a third spray fan having a third fan width. In some examples, the first fan width is the same as the second fan width. In some examples, the first fan width is the same as the third fan width. In some examples, an overlap between the first spray fan and the second spray fan is the same as an overlap between the first spray fan and the third spray fan. In some examples, a spray fan generated by nozzle 44 of the spray module 20b does not overlap with a spray fan generated by nozzle 44 of the spray module 20c. In some examples, a spray fan generated by nozzle 44 of spray module 20b does overlap with a spray fan generated by nozzle 44 of the spray module 20c. In some examples, a spray fan generated by nozzle 44 of the spray module 20a does overlap with the spray fan emitted by spray module 20b and/or spray module 20c.

In some examples, each of the module groupings are aligned on a centerline of the vertical displacer of the spray modules 20. In some examples, the operative groupings are aligned on the midline LM of the mobile sprayer 10′. For example, the spray swaths output by each operative grouping can be centered on the midline LM. Locating the spray module 20a used for single nozzle operation coaxial with the centerline may simplify navigating transitions rather than having the single nozzle spray module 20a be asymmetrically closer to either of the leading side 58 or the trailing side 60.

In some examples, sprayer controller 28 can be configured to individually control spraying by individual ones of the spray modules 20 in a multi-module grouping. For example, the sprayer controller 28 can be configured to cause the outer spray module 20b to spray while preventing the outer spray module 20c from spraying and/or to cause the spray module 20c to spray while preventing the outer spray module 20b from spraying. As such, the sprayer controller 28 can be configured to operate mobile sprayer 10′ in multiple operating modes and to control spraying from various module groups based on the operating mode. The sprayer controller 28 can further be configured to control spraying such that only a single spray module 20, whether in the single-module group or the multi-module group, emits the spray fluid. In other examples, the sprayer controller 28 can cause inter-group spraying, such as spraying by spray module 20a and one or both of the outer spray modules 20b, 20c.

Mobile sprayer 10′ provides significant advantages. Mobile sprayer 10′ includes multiple spray modules 20. The multiple spray modules 20 are configured such that the multiple spray modules 20 can be displaced vertically together and can be actively controlled to spray relative to each other. The multiple spray modules 20 facilitate applying a higher volume of fluid onto the target surface 54 with each vertical swath as compared to a single spray head. Such a configuration thereby facilitates quicker and more efficient spray operations.

The multiple spray modules 20 can be grouped into module groups for spraying onto the target surface 54. The sprayer controller 28 can cause the outer module group, which can include a pair of spray modules 20 or more than two spray modules 20, to apply spray fluid to the wall when operating in a first spray mode. The sprayer controller 28 can cause the central module grouping, which includes a single spray module 20 in this example but can include more, to apply spray fluid to the wall when operating in a second spray mode. The first spray mode can be utilized when spraying on straight sections of the wall, allowing for quicker, higher volume spray application. The second spray mode can be utilized when spraying transition portions of the wall, allowing for finer and more detailed spraying in such transitions.

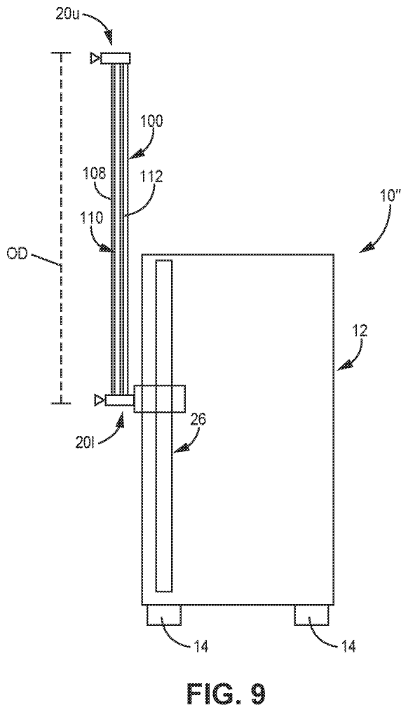

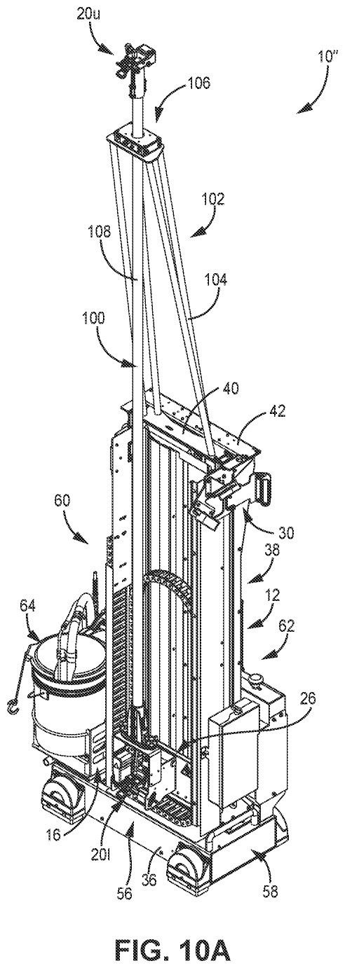

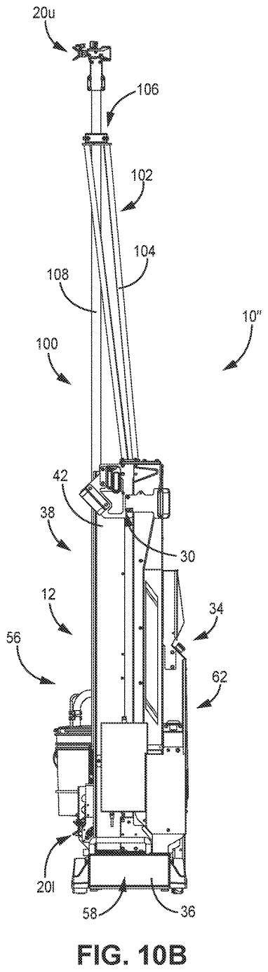

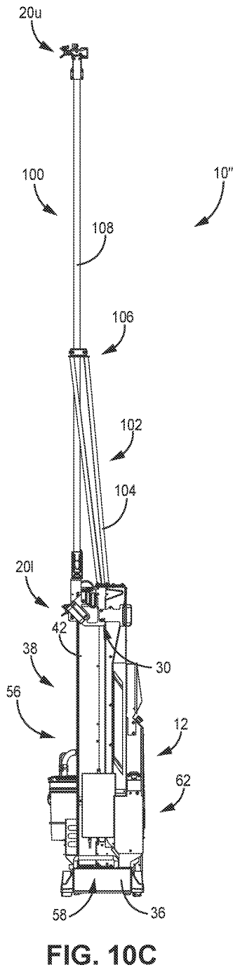

FIG. 9 is a side block diagram of mobile sprayer 10″. FIG. 10A is an isometric view of mobile sprayer 10″. FIG. 10B is a side elevational view showing mobile sprayer 10″ with the spray assembly in a lower spray position. FIG. 10C is a side elevational view showing mobile sprayer 10″ with the spray assembly in a raised spray position. FIGS. 9-10C are discussed together. Mobile sprayer 10″ is substantially similar to mobile sprayer 10 (best seen in FIGS. 1A-3) and mobile sprayer 10′ (FIGS. 6-7B), except that mobile sprayer 10″ includes trunk 100 that supports spray module 20u.

Trunk 100 extends vertically above mobile sprayer 10″. Trunk 100 is configured to raise a spray nozzle 44 of the upper spray module 20u above the frame 12 of the mobile sprayer 10″ to spray swaths that are taller than the frame 12 of the mobile sprayer 10″. The trunk 100 can extend such that the spray module 20u is disposed vertically above the frame 12 regardless of the vertical position of the lower spray module 20l. The trunk 100 can extend above the frame 12 with the upper mast 38 extended and with the upper mast 38 retracted.

In some examples, the trunk 100 is mounted to the spray module 20l, which forms a lower spray module 20 of the mobile sprayer 10″. The spray module 20u that is supported by the trunk 100 forms an upper spray module 20u of the mobile sprayer 10″. In the example shown, the trunk 100 is mounted to the lower spray module 20l such that the trunk 100 moves up and down as the spray module 20l is moved up and down via the elevator 26. The lower spray module 20l and upper spray module 20u can be considered to form a spray assembly configured to apply vertically elongated swaths of spray fluid on the target surface 54. The upper spray module 20u and the lower spray module 20l are oriented to spray out from the wall-facing side 56. In the example shown, the upper spray module 20u is cantilevered from the lower spray module 20l by the trunk 100.

In some examples, trunk 100 extends above other portions of mobile sprayer 10″ such that the upper spray module 20u is disposed outside of the sensing envelope of the sensors 30 of the mobile sprayer 10″. In some examples, the upper spray module 20u can be configured to be disposed vertically above the sensing envelope both at a lower limit of travel of the upper spray module 20u and at an upper limit of travel of the upper spray module 20u. The mobile sprayer 10″ can thus be configured to apply coatings at locations in unsensed regions of the target surface.

In the example shown, frame 12 incudes upper support 102. Upper support 102 extends vertically above mast 38. In the example shown, upper support 102 is connected to upper mast 38 such that upper support 102 can move vertically with upper mast 38. Elevator 26 can move relative to upper support 102 such that lower spray module 20l and upper spray module 20u can move relative to upper support 102. Upper support 102 is configured to interface with trunk 100 to support trunk 100 vertically above frame 12. Upper support 102 is configured to interface with trunk 100 to support trunk 100 vertically above the lower spray module 20l. Trunk 100 can move vertically relative to upper support 102.

Upper support 102 includes arms 104 and trunk retainer 106. Arms 104 extend vertically upwards relative to mast 38. Arms 104 extend vertically from mast 38. In the example shown, upper support 102 includes a plurality of arms 104 that converge towards each other as the arms 104 extend vertically away from mast 38. The arms 104 converge towards each other and connect to trunk retainer 106. Trunk retainer 106 is configured to interface with trunk 100 and maintain trunk 100 vertically aligned. The trunk retainer 106 can align trunk 100 such that the lower spray module 20l and upper spray module 20u are disposed to apply vertical stripes that are directly vertically aligned to form the elongated vertical swath. The trunk retainer 106 can be and/or include a linear bearing that facilitates sliding displacement of the trunk 100 relative to the trunk retainer 106.

In some examples, trunk 100 can be selectively connected to mobile sprayer 10″. Trunk 100 can be connected to mobile sprayer 10″ to elongate the vertical spray reach of mobile sprayer 10″ and can be disconnected from mobile sprayer 10″ during spraying of surfaces within the vertical reach of mobile sprayer 10″. In some examples, upper support 102 can be selectively connected to mobile sprayer 10″ such that upper support 102 can be connected and disconnected with mounting of trunk 100.

While the upper spray module 20u is shown as disposed above the frame 12, it is understood that not all examples are so limited. For example, mobile sprayer 10″ can include multiple spray modules 20 that are vertically stacked relative to each other but are within the frame 12, similar to the spray modules 20a-20c of mobile sprayer 10′ except stacked vertically. The vertically stacked spray modules 20 can be spaced from each other (e.g., such that each spray module applied half of a stripe. The vertically stacked spray modules 20 can be positioned to simultaneously spray at a common location for dual coating on a single pass.

In the example shown, both of the upper and lower spray modules 20l, 20u includes a spray valve 46 and a spray nozzle 44. The spray valve 46 is actuatable between an open state, in which spray fluid can flow to the spray nozzle 44 to be atomized by the spray nozzle 44, and a closed state, in which the spray valve 46 prevents the spray fluid from flowing to and through the spray nozzle 44. The spray modules 20l, 20u further include a valve actuator 48. The valve actuator 48 is operatively connected to the spray valve 46 to control actuation of the spray valve 46. The valve actuator 48 can be configured to mechanically displace the spray valve 46. The valve actuator 48 can be formed by one or more components. For example, the valve actuator 48 can includes a first component configured to displace the spray valve 46 to the open state and a second component configured to displace the spray valve 46 to the closed state. In some examples, the valve actuator 48 can include a solenoid. The sprayer controller 28 can control actuation of the solenoid, such as by controlling provision of electrical energy to the solenoid, to control actuation of the spray valve 46. In some examples, the solenoid can be a single acting solenoid configured to displace the spray valve 46 from one state to the other (e.g., from closed to open). In some examples, the solenoid can be a double acting solenoid configured to displace the spray valve 46 between the states (e.g., from closed to open and from open to closed). In some examples, the valve actuator 48 can include a spring configured to actuate the spray valve 46 to the closed state. For example, valve actuator 48 can be configured such that a solenoid electromechanically pulls the spray valve 46 open and a spring mechanically returns the spray valve 46 closed.

In some examples, the spray valves 46 are configured as pressure actuated valves that are closed by respective springs when the pressure of the spray fluid is below a threshold pressure but opened up by the pressure when the pressure of the spray is above the threshold corresponding to when the spray module 20 sprays.

In some examples, the valve actuators 48 differ between spray modules 20l, 20u. For example, the lower spray module 20l can include a solenoid for opening its spray valve 46 and the upper spray module 20u can include a pressure actuated spray valve 46. In some examples, the sprayer controller 28 actively controls opening of the spray valve 46 of the lower spray module 20l which allows flow both to the nozzle 44 of the lower spray module 20 and to the spray valve 46 and nozzle 44 of the upper spray module 20. As such, some examples can include the spray modules 20l, 20u fluidly connected in series to receive the spray fluid. Other examples can include the spray modules 20l, 20b fluidly connected in parallel to receive the spray fluid.

In some examples, the solenoid-actuated spray valve 46 is located within the spray module 20l, such that the lower spray module 20l and its solenoid-actuated spray valve 46 does not extend above the frame 12 but an outlet nozzle 44 of the upper spray module 20u does extend above the frame 12. As shown, two outlet nozzles 44 of the spray modules 20l, 20u are controlled by movement of the lower spray module 20l. In this way, one vertical movement can spray a swath that extends from the base 36 of the mobile sprayer 10″ to well above the frame 12 of the mobile sprayer 10″.

In some examples, each of the upper spray module 20u and the lower spray module 20l can be fluidly connected to a common pump module 86, in series or in parallel. A single pump 88 can drive the spray fluid to both the lower and upper spray modules 20l, 20u for spraying by both of the upper and lower nozzles 44. In some examples, the mobile sprayer 10″ can be configured such that a single valve, such as spray valve 46 of spray module 20l, can be actively controlled, such as by sprayer controller 28 and a solenoid, to control flow of pressurized spray fluid to both the nozzle 44 of the upper spray module and the nozzle 44 of the lower spray module.

In some examples, a flow control valve, such as an actively controlled flow control valve, can be disposed upstream of both the spray modules 20l, 20u. The spray valves 46 of the spray modules 20l, 20u can be pressure actuated valves that are closed by respective springs when the pressure of the spray fluid is below a threshold pressure but opened up by the spray fluid pressure when the pressure of the spray fluid is above the threshold corresponding to when the spray module 20 sprays. The sprayer controller 28 can cause the flow control valve to open to allow flow to the spray modules 20 to cause spraying and can cause the flow control valve to close to stop flow to the spray modules 20 to stop spraying by the spray modules 20.

In some examples, the upper and lower spray modules 20l, 20u can be fluidly connected to a single pump module 86 and can each include actively controlled spray valves 46. For example, the lower spray module 20 can include a first spray valve 46 opened by a solenoid and the upper spray module 20 can include a second spray valve 46 opened by a solenoid.

In some examples, the upper spray module 20u and the lower spray module 20l are fluidly connected to separate pump modules 86 to receive the pressurized spray fluid from the separate pump modules 86. For example, a first pump module 86 can provide pressurized spray fluid to the lower spray module 20l and a second pump module 86 can provide pressurized spray fluid to the upper spray module 20u.

One or both of the lower and upper spray modules 20l, 20u can include a nozzle actuator 96 configured to reorient the spray nozzle 44 relative to the target surface. The nozzle actuators 96 can reposition the nozzles 44 between upward and downward tilt orientations. Such a configuration facilitates spraying above and/or below the travel limits of the lower spray module 20l and/or upper spray module 20u.

In some examples, one or both of the nozzle actuators 96 are unidirectional actuators. A unidirectional nozzle actuator 96 is configured to tilt the nozzle 44 between orthogonal and one or the other of the upward tilt and downward tilt orientations. For example, the nozzle actuator 96 of the lower spray module 20l can be configured to reorient the nozzle 44 of the lower spray module 20l downward, while the nozzle actuator 96 of the upper spray module 20u can additionally or alternatively be configured to reorient the nozzle 44 of the upper spray module 20u upward.

In some examples, one or both of the nozzle actuators 96 are bidirectional actuators. A bidirectional pivot actuator is configured to tilt the nozzle 44 between orthogonal and the upward tilt orientation and between orthogonal and the downward tilt orientation.

During operation, mobile sprayer 10″ can be configured to apply one or multiple fluid swaths on the target surface 54. The mobile sprayer 10″ can be configured to apply stacked vertical swaths. The stacked vertical swaths can meet such that the mobile sprayer 10″ sprays a single elongated vertical stripe that is formed by the stacked vertical swaths. The elongated vertical stripe is elongated relative to a height of the frame 12 of the mobile sprayer 10″. The elongated vertical stripe can be up to or greater than twice the possible travel distance of the spray module 20l between upper and lower travel limits.

The upper spray module 20u is spaced vertically from the lower spray module 20l by an offset distance OD. The offset distance OD is a vertical distance between the nozzle 44 of spray module 20l and the nozzle 44 of spray module 20u. In some examples, the spray module 20u is fixed relative to the spray module 20l such that the offset distance OD remains fixed throughout operation. In other examples, the spray module 20l can be movable vertically relative to the spray module 20u and/or the spray module 20u can be movable vertically relative to the spray module 20l, such that the offset distance OD can vary during operation.

The offset distance OD can be set such that the lower spray module 20l moves the offset distance OD between a lower travel limit of spray module 20l and an upper travel limit of spray module 20l. In such a configuration, during upward movement for a vertical stripe an end of the swath of spray fluid applied by spray module 20l meets with a beginning of the swath of spray fluid applied by spray module 20u, forming a continuous vertical stripe. During downward movement for a vertical stripe an end of the swath of spray fluid applied by spray module 20u meets with a beginning of the swath of spray fluid applied by spray module 20l, forming a continuous vertical stripe. As such, the vertical swaths applied by the upper and lower spray modules 20u, 20l can, in some examples, meet and can at least partially overlap.

In some examples, an upper limit of travel for the lower spray module 20l is disposed vertically below a lower limit of travel for the upper spray module 20u. In some examples, an upper limit of travel for the lower spray module 20l one of reaches and is disposed vertically above a lower limit of travel for the upper spray module 20u. In some examples, a vertical height of the single vertical swath formed by the combination of swaths applied by the upper and lower spray modules 20u, 20l is greater than a combination of a travel distance of the lower spray module 20l and a travel distance of the upper spray module 20u. The combination of the travel distance of the lower spray module 20l and the upper spray module 20u can, in some examples, be equal to twice the travel distance of the lower spray module 20l.

Spray module 20u is fluidly connected to a fluid source to receive pressurized spray fluid from the fluid source. Spray module 20u can, in some examples, be operatively connected, electrically and/or communicatively, with other electrical components of mobile sprayer 10″ (e.g., sprayer controller 28, power module 32, etc.). In some examples, spray module 20u is fluidly connected to receive pressurized spray fluid through trunk 100. For example, trunk 100 can include a trunk body 108 that can structurally support spray module 20u. A fluid hose 110 can extend within trunk that is fluidly connected to the spray module 20u to provide pressurized spray fluid to spray module 20u. The fluid hose 110 can, in some examples, be disposed within the trunk body 108 to protect the fluid hose 110. In some examples, conductors 112 can be disposed in the trunk body 108 to electrically connect the spray module 20 to the sprayer controller 28. For example, the conductors 112 can be formed from one or more wires, preferably copper, that extend between spray module 20u and sprayer controller 28. In some examples, the conductors 112 can provide power to a solenoid of the valve actuator 48 of spray module 20u to control operation of the spray valve 46 of spray module 20u. As such, trunk 100 can, in some examples, be configured to route both fluid and electrical signals between spray module 20u and other components of mobile sprayer 10″.

In some examples, mobile sprayer 10″ can be configured such that one or both of the lower and upper spray modules 20l, 20u can spray independently of the other lower and upper spray module 20l, 20u. For example, sprayer controller 28 can be configured to cause mobile sprayer 10″ to operate in an upper spray mode and/or a lower spray mode.

In the upper spray mode, the sprayer controller 28 can cause the mobile sprayer 10″ to emit spray fluid from the upper spray module 20u and not from the lower spray module 20l. In such a configuration, the mobile sprayer 10″ can apply spray coatings to surfaces that are above frame 12, whereas structure aligned with frame 12 are not meant to be coated (e.g., portions formed by windows, doorways, breezeways, archways, or other openings).

In the lower spray mode, the sprayer controller 28 can cause the mobile sprayer 10″ to emit spray fluid from the lower spray module 20l and not from the upper spray module 20u. In such a configuration, the mobile sprayer 10″ can apply spray coatings to surfaces that are aligned with frame 12, whereas structures or areas above frame 12 are not meant to be coated.

In some examples, the sprayer controller 28 can cause the mobile sprayer 10″ to transition between emitting spray fluid from both spray modules 20l, 20u to emitting spray fluid from one or the other of spray modules 20l, 20u. During operation, the sprayer controller 28 can control spraying by the upper and lower spray modules 20l, 20u to apply an elongated vertical swath having a consistent coating thickness. For example, mobile sprayer 10″ can be configured to apply coating to a surface with gaps (e.g., window openings, etc.) formed between upper areas that are meant to be coated and can prevent the upper spray module 20u from spraying into those gaps.

Trunk 100 can be removable and replaceable on mobile sprayer 10″. the surface on which the spray fluid is applied may have a vertical height less than the possible reach of the mobile sprayer 10″. In some examples, the mobile sprayer 10″ can be configured such that trunks 100 of different lengths can be connected to mobile sprayer 10″ to facilitate spraying of surfaces having different heights. For example, the target surface may be taller than the frame 12 but may have a top junction (e.g., ceiling and wall) that is shorter than the overall height of the longest trunk 100 when that longest trunk 100 is connected to mobile sprayer 10″ and extended upward. In such an example, a trunk 100 having a different length can be selected and connected to mobile sprayer 10″. Having a trunk 100 with a reduced length positions the upper spray module 20u aligned with the wall at a location along the wall that the lower spray module 20l will align with and traverse over prior to reaching an upward limit defined by the top of the wall. The reduced length trunk 100 can be configured such that the lower spray module 20l still travels fully between upper and lower travel limits.

In some upward swath examples, the sprayer controller 28 can cause the lower spray module 20l to stop emitting spray fluid (e.g., by causing a spray valve 46 of the lower spray module 20l to close) based on the lower spray module 20l reaching a starting position of the upper spray module 20u. The upper spray module 20u can be caused to spray from a starting position of the upper spray module 20u to the upper limit of travel. In some upward swath examples, the sprayer controller 28 can cause the upper spray module 20u to start emitting spray fluid (e.g., by causing a spray valve 46 of the upper spray module 20u to open) based on the upper spray module 20u reaching a location aligned with the upward end of travel of the lower spray module 20l.

In some additional or alternative upward swath examples, the sprayer controller 28 can cause the upper spray module 20u to stop emitting spray fluid based on the upper spray module 20 reaching a defined spray limit. For example, the upper spray module 20 may be able to extend vertically above the desired height of the vertical swath. In such an example, the sprayer controller 28 can cause the upper spray module 20u to stop spraying prior to the lower spray module 20l stopping spraying.

The lower spray module 20l can be caused to spray from a starting position of the lower spray module 20l to the upper limit of travel of the lower spray module 20l. Such spray configurations align the swaths of the upper and lower spray modules 20 without creating coating thickness variations that can be caused by applying different numbers of coats at different locations on the surface.

In some downward swath examples, the sprayer controller 28 can cause the upper spray module 20u to stop emitting spray fluid (e.g., by causing a spray valve 46 of the upper spray module 20u to close) based on the upper spray module 20u reaching a starting position of the lower spray module 20l. The lower spray module 20l can be caused to spray from a starting position of the lower spray module 20l to the lower limit of travel of the lower spray module 20l.

In some additional or alternative downward swath examples, the sprayer controller 28 can cause the lower spray module 20l to start emitting spray fluid (e.g., by causing a spray valve 46 of the lower spray module 20l to open) based on the lower spray module 20l reaching a location aligned with the downward end of travel of the upper spray module 20u. The lower spray module 20l can begin emitting fluid prior to the upper spray module 20u reaching that downward end of travel.

In some additional or alternative downward swath examples, the sprayer controller 28 can cause the upper spray module 20u to start emitting spray fluid based on the upper spray module 20u reaching a defined spray limit. In examples in which the upper spray module 20u can extend vertically above the desired height of the vertical swath, the sprayer controller 28 can cause the upper spray module 20u to start spraying after the lower spray module 20l starts spraying as the upper spray module 20u needs to displace some vertical distance to reach that defined spray limit.

The upper spray module 20u can be caused to spray from a starting position of the upper spray module 20u to the lower limit of travel of the upper spray module 20u. Such a spray configuration aligns the swaths of the upper and lower spray modules 20 without creating coating thickness variations that can be caused by applying different numbers of coats at different locations on the surface.

In some examples, the sprayer controller 28 can be configured to control spraying by the upper and lower spray modules 20l, 20u based on vertical positions of the nozzles 44 of the spray modules 20. For example, the sprayer controller 28 can determine the relative vertical positions of the nozzles 44 based on the displacement of the elevator 26 and length of trunk 100. The sprayer controller 28 can cause the spray modules 20l, 20u to start or stop spraying based on the determined position of the nozzle 44 relative to the determined position of the other nozzle 44 when applying spray fluid. Sprayer controller 28 can be configured to determine the vertical position of the nozzle 44 in any suitable manner, such as based on information regarding displacement of elevator 26, such as generated based on information from one or more sensors, such as one or more of an encoder sensing displacement of spray module 20, a sensor sensing operation (e.g., rotations) of drive motor 22, a sensor sensing operation (e.g., rotations) of movement motors 24, etc.

In some examples, the sprayer controller 28 can be configured to control spraying by the upper and lower spray modules 20l, 20u based on vertical positions of the spray pattern on the target surface. For example, the sprayer controller 28 can determine the relative vertical positions of the spray pattern based on the displacement of the elevator 26, length of trunk 100, a distance of nozzles 44 from the surface, and the relative orientations of the nozzles 44. The sprayer controller 28 can cause the spray modules 20l, 20u to start or stop spraying based on the determined position of the spray pattern on the surface from a first one of the spray modules 20l, 20u relative to the determined position of the spray pattern on the surface from the other one of the spray modules 20l, 20u. Sprayer controller 28 can be configured to determine the vertical position of the spray pattern based on the angular displacement of the nozzle 44 when reorienting and the distance from the target surface, which provides the additional distance reached by the reoriented spray pattern which can spray above and/or below the travel limits for the nozzles 44.

In some examples, the sprayer controller 28 can cause the nozzles 44 of both of the lower spray module 20l and upper spray module 20u to reorient to cause the individual vertical swaths to meet to form the vertical stripe. The sprayer controller 28 can cause the lower spray module 20l to reorient to an upward tilt orientation at the end of upward displacement (or begin in an upward tilt orientation at the beginning of downward displacement). The sprayer controller 28 can cause the upper spray module 20b to reorient to a downward tilt orientation at the end of downward displacement (or begin in a downward tilt orientation at the beginning of upward displacement). Such reorientation can cause the stripes to meet even if the nozzles do not overlap in vertical position. For example, the stripes can overlap even where an upper limit of travel of the lower spray module 20l is vertically below a lower limit of travel of the upper spray module 20u. In such a configuration, the offset distance OD can be greater than the possible travel distance for the lower spray module 20l between upper and lower travel limits of the lower spray module 20l.

In some upward vertical swath examples, the sprayer controller 28 can cause the lower nozzle 44 to tilt to the upward spray orientation at the end of upward travel and can cause the upper spray module 20u to start spraying based on an anticipated end location of the spray pattern applied by the lower spray module 20l. The spray pattern of the upper spray module 20u can begin at the anticipated end location where the spray pattern of the lower spray module 20l ends. The sprayer controller 28 can align the nozzle 44 of the upper spray module 20u such that the anticipated location of the spray emitted from the upper spray module 20u will begin at the anticipated end location of the swath from the lower spray module 20l. Sprayer controller 28 can cause the upper spray module 20u to begin emitting the fluid spray based on the anticipated end location for the swath from the lower spray module 20l.

The sprayer controller 28 can align the nozzle 44 based on an anticipated start location at which the spray pattern from the nozzle 44 of the upper spray module 20u will be applied on the surface. The sprayer controller 28 can be configured to determine nozzle alignment for application of the spray pattern with the nozzle 44 of the upper spray module 20u in any orientation between and including downward and upward tilt orientations. The sprayer controller 28 can be configured to determine the anticipated end location for the swath from the lower spray module 20l based on tilt orientations and distance from the surface. The sprayer controller 28 can be configured to determine the anticipated start location for the swath from the upper spray module 20u based on tilt orientations and distance from the surface.

In some additional or alternative upward vertical swath examples, the sprayer controller 28 can control spraying by the lower spray module 20l based on a determined start location for the beginning of the spray pattern from the upper spray module 20u. The sprayer controller 28 can control spraying by the lower spray module 20l such that the spray pattern of the lower spray module 20l ends at the determined location where the spray pattern of the upper spray module 20u began. The sprayer controller 28 can cause the lower spray module 20l to stop emitting the fluid spray based on nozzle 44 or pattern alignment relative to the determined start location. The sprayer controller 28 can align the nozzle 44 of the lower spray module 20l based on the determined start location and can cause the lower spray module 20l to stop spraying based on the determined start location. The fluid swath applied by the lower spray module 20l will thus meet the fluid swath from the upper spray module 20u to form the elongated vertical stripe.

In some downward vertical swath examples, the sprayer controller 28 can cause the upper nozzle 44 of the upper spray module 20u to tilt to the downward spray orientation at the end of downward travel and can cause the lower spray module 20l to start spraying based on an anticipated end location of the spray pattern applied by the upper spray module 20u. The sprayer controller 28 can control spraying such that the spray pattern of the lower spray module 20l begins at the anticipated end location where the spray pattern of the upper spray module 20u ends. The sprayer controller 28 can align the nozzle 44 of the lower spray module 20l with the anticipated end location and cause the lower spray module 20l to begin emitting the fluid spray at the beginning of the downward vertical swath. The sprayer controller 28 aligns the nozzle 44 based on an anticipated start location at which the spray pattern from the nozzle 44 of the lower spray module 20l will be applied on the surface. The sprayer controller 28 can be configured to determine nozzle alignment for application of the spray pattern with the nozzle 44 of the lower spray module 20l in any orientation between and including downward and upward tilt. The sprayer controller 28 can be configured to determine the anticipated end location for the swath from the upper spray module 20u based on tilt orientations and distance from the surface. The sprayer controller 28 can be configured to determine the anticipated start location for the swath from the lower spray module 20l based on tilt orientations and distance from the surface.

In some additional or alternative downward vertical swath examples, the sprayer controller 28 can control spraying by the upper spray module 20u based on a determined start location for the beginning of the spray swath from the lower spray module 20l. In such an example, the sprayer controller 28 controls spraying by the upper spray module 20u such that of the swath from the upper spray module 20u ends at the determined start location for the swath from the lower spray module 20l. The sprayer controller 28 can align the nozzle 44 of the upper spray module 20u with the determined start location and cause the upper spray module 20b to stop emitting the fluid spray based on the determined start location.

The sprayer controller 28 aligns the nozzle 44 of the upper spray module 20u based on an anticipated end location at which the spray pattern from the nozzle 44 of the upper spray module 20u will be applied on the surface. The sprayer controller 28 can be configured to determine nozzle alignment for application of the spray pattern with the nozzle 44 of the upper spray module 20u in any orientation between and including downward and upward tilt. The sprayer controller 28 can be configured to determine the anticipated end location based on tilt orientations and distance from the surface. The sprayer controller 28 can be configured to determine the determined start location for the swath from the lower spray module 20l based on tilt orientations and distance from the surface.

Mobile sprayer 10″ can be configured such that the vertical swaths applied by each of the lower and upper spray modules 20l, 20u overlap or otherwise meet but such that the spray modules 20l, 20b themselves do not pass over the same locations on the surface. Mobile sprayer 10″ can be configured such that the vertical swaths applied by each spray module 20l, 20u overlap or otherwise meet but such that the nozzles 44 of each spray module 20l, 20b do not themselves pass over the same locations on the surface. Mobile sprayer 10″ can be configured such that the vertical stripes applied by each spray module 20l, 20u overlap or otherwise meet but such that the vertical swath has a length greater than a combined travel distance of the spray modules 20l, 20u (e.g., due to reorientation of the nozzles 44).

The emission of spray fluid can be staged such that vertical swaths are formed by a uniform number of coating passes over the vertical height of the vertical stripe (e.g., over at least a large majority of the stripe (e.g., 90% or greater)). The spray modules 20l, 20u can concurrently apply spray fluid for portions of the swath that are not sprayed by the other spray module 20l, 20u. The sprayer controller 28 can cause one of the spray modules 20l, 20u to stop spraying while the other spray module 20l, 20u continues spraying to apply the vertical stripe. The vertical stripes applied by the spray modules 20l, 20u can be considered to form stacked swaths that can combine to form the elongated vertical stripe.

In some examples, the sprayer controller 28 is configured to control spraying by both the lower spray module 20l and the upper spray module 20u in a simultaneous spray mode and in a separate spray mode. In the simultaneous spray mode, the sprayer controller 28 can cause the lower spray module 20l and the upper spray module 20u to emit the fluid simultaneously. In the separate spray mode, the sprayer controller 28 can cause one of the lower spray module 20l and the upper spray module 20u to emit the fluid and prevent the other one of the lower spray module 20l and the upper spray module 20u from emitting the fluid. The sprayer controller 28 can be configured to operate in both the simultaneous spray and the separate spray mode during application of a single elongated vertical stripe.

Mobile sprayer 10″ provides significant advantages. Trunk 100 extends vertically and can position an upper spray module 20u above the frame 12 of the mobile sprayer 10″. The trunk 100 positions the upper spray module 20u to increase the vertical spray reach of the mobile sprayer 10″. Such a configuration facilitates quick and efficient coating of areas that were previously inaccessible by autonomous spraying and required manual painting, such as on a ladder that required set up, break down, and storage. Such a configuration thereby also facilitates safer and less time consuming spray application.

The upper spray module 20u and lower spray module 20l can be configured to apply individual vertical swaths that can combine to form a single vertical stripe on the target surface. Stacking the vertical swaths facilitates quick and efficient spraying of vertical stripes on a target surface. Each spray module 20l, 20u applies a portion of the vertical stripe, which stripe has a length greater than the length of the swath applied by either spray module 20l, 20u. Sprayer controller 28 can, in some examples, control spraying from each spray module 20l, 20u individually, providing for even coating of the surface by the vertical stripes formed by multiple vertical swaths. The spray modules 20l, 20u can simultaneously apply the spray fluid to the surface, further providing for efficient and quick spray operations.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A mobile sprayer for spraying a plurality of vertical swaths of a fluid on a wall, the mobile sprayer comprising:
a wall-facing side configured to be oriented towards the wall, an outer side configured to be oriented away from the wall, a leading side, and a trailing side;
a frame including a base having a longitudinal axis and a lateral axis;
a plurality of base displacers configured to move the base along a ground surface;
one or more driving motors that drive the plurality of base displacers;
a spray module configured to spray the fluid onto the wall, the spray module mounted to spray out from the wall facing side;
one or more movement motors configured to move the spray module relative to the base;
one or more sensors that generate data regarding one or more parameters relating to the wall;
a reservoir support configured to support a reservoir on the base, the reservoir configured to store a supply of the fluid on the base, the reservoir support disposed laterally between the spray module and the trailing side; and
a sprayer controller configured to receive the data generated by the one or more sensors and control the one or more driving motors, the one or more movement motors, and the spray module.

2. The mobile sprayer of claim 1, wherein the reservoir support includes a base support and a side support, wherein the side support projects from the base support to define a reservoir receiving area.

3. The mobile sprayer of claim 2, wherein the side support extends fully about the reservoir receiving area.

4. The mobile sprayer of claim 3, wherein the side support includes an annular ring that extends fully about the reservoir receiving area.

5. The mobile sprayer of claim 4, wherein the annular ring is spaced vertically from the base support.

6. (canceled)

7. The mobile sprayer of claim 1, wherein:
the plurality of displacers includes at least one forward displacer and at least one rear displacer;
the reservoir support is disposed directly vertically above a rotational axis of the at least one rear displacer.

8. The mobile sprayer of claim 1, wherein:
the plurality of displacers includes at least one forward displacer and at least one rear displacer;
the reservoir support is disposed directly vertically above the at least one rear displacer.

9. (canceled)

10. (canceled)

11. The mobile sprayer of claim 1, further comprising:
a pumping assembly including a pump configured to drive the fluid from the reservoir to the spray module under pressure, the pumping assembly disposed laterally between the spray module and the trailing side.

12. The mobile sprayer of claim 11, wherein the pumping assembly includes an electric motor.

13. The mobile sprayer of claim 11, wherein the pumping assembly includes a pump battery configured to supply power for driving the pump.

14. (canceled)

15. (canceled)

16. The mobile sprayer of claim 1, wherein the reservoir support is at least partially disposed over a first base area of the base formed between the spray module and the trailing side and between a first one of the outward side and the wall-facing side and the lateral axis.

17. The mobile sprayer of claim 16, wherein a pump is at least partially disposed over a second base area of the base, the second base area formed between the spray module and the trailing side and between a second one of the outward side and the wall-facing side and the lateral axis.

18. (canceled)

19. (canceled)

20. The mobile sprayer of claim 1, wherein the reservoir support is located in a first corner formed by the trailing side and one of the wall-facing side and the outward side.

21. The mobile sprayer of claim 20, wherein a pump is located in a second corner formed by the trailing side and the other of the wall-facing side and the outward side.

22. The mobile sprayer of claim 1, wherein the spray module is supported by a mast that extends vertically upward from the base, and wherein the reservoir support is disposed laterally rearward of the mast.

23. (canceled)

24. The mobile sprayer of claim 1, wherein the reservoir support is configured to displace vertically relative to the base such that the reservoir support is positionable at a plurality of different heights away from the base.

25. (canceled)

26. (canceled)

27. The mobile sprayer of claim 1, wherein the sprayer controller is configured to control operation of the one or more drive motors such that the mobile sprayer displaces unidirectionally along flat portions of the wall towards the leading side.

28. The mobile sprayer of claim 1, wherein the sprayer controller does not cause the mobile sprayer to displace towards the trailing end between adjacent vertical swaths of the plurality of vertical swaths along flat portions of the wall.

29. (canceled)

30. (canceled)

31. A mobile sprayer for spraying a plurality of vertical swaths of a fluid on a wall, the mobile sprayer comprising:
a wall facing side configured to be oriented towards the wall, an outer side configured to be oriented away from the wall, a leading side, and a trailing side;
a frame including a base having a longitudinal axis and a lateral axis;
a plurality of base displacers configured to move the base along a ground surface;
one or more driving motors that drive the plurality of base displacers;
a spray module configured to spray the fluid onto the wall, the spray module mounted to spray out from the wall facing side;
one or more movement motors that are configured to move the spray module relative to the base;
one or more sensors that generate data regarding one or more parameters relating to the wall;
a reservoir supported on the base, the reservoir configured to store a supply of the spray fluid, the reservoir disposed laterally rearward relative to the spray module; and
a sprayer controller configured to receive the data generated by the one or more sensors and control the one or more driving motors, the one or more movement motors, and the spray module.

32. A mobile sprayer for spraying a plurality of vertical swaths of a fluid on a wall, the mobile sprayer comprising:
a wall facing side configured to be oriented towards the wall, an outer side configured to be oriented away from the wall, a leading side, and a trailing side;
a frame having a base having a longitudinal axis and a lateral axis;
a plurality of base displacers configured to move the base along a ground surface;
one or more driving motors that drive the plurality of base displacers;
a spray module configured to spray a fluid onto the wall, the spray module mounted to spray out from the wall facing side;
one or more movement motors that are configured to move the spray module relative to the base;
one or more sensors that generate data regarding one or more parameters relating to the wall;
a reservoir supports configured to support a reservoir on the base, the reservoir configured to store a supply of the spray fluid, the reservoir support disposed laterally rearward relative to the spray module;
a pump supported on the base, the pump configured to drive the spray fluid from the reservoir to the spray module, the pump disposed laterally rearward of the one or more spray modules; and
a sprayer controller configured to receive the data generated by the one or more sensors and control the one or more driving motors, the one or more movement motors, and the spray module.

33-166. (canceled)
